(19) United States
(12) Patent Application Publication
(10) Pub. No.: US 2012/0281166 A1
(43) Pub. Date: Nov. 8, 2012

(54) LIGHT GUIDE PLATE, SURFACE ILLUMINATING DEVICE, AND LIQUID CRYSTAL DISPLAY DEVICE

(75) Inventor: Osamu Iwasaki, Ashigara-kami-gun (JP)

(73) Assignee: FUJIFILM CORPORATION, Minato-Ku, Tokyo (JP)

(21) Appl. No.: 13/522,189

(22) PCT Filed: Jan. 12, 2011
(86) PCT No.: PCT/JP2011/050334

§ 371 Date: Jul. 13, 2012

(30) Foreign Application Priority Data
Jan. 13, 2010 (JP) 2010-004961
Feb. 24, 2010 (JP) 2010-038150
May 14, 2010 (JP) 2010-111883

(51) Int. Cl. F21V 8/00; G02F 1/13357

(52) U.S. Cl. 349/65; 362/606

(57) ABSTRACT

To provide a light guide plate yielding a high light use efficiency and capable of emitting light with minimized unevenness in luminance and yielding a distribution such that the central area of the screen is brighter than the periphery, a light guide plate includes a rectangular light exit plane, and a light entrance plane for admitting light traveling substantially parallel to the light exit plane, a rear plane provided opposite from the light exit plane, and scattering particles dispersed inside, the light guide plate further including two or more layers lying on one another in a direction substantially perpendicular to the light exit plane and having different particle densities of scattering particles, the two or more layers including a first layer having a particle density of Npo and a second layer having a particle density of Npr and located closer to the rear plane than the first layer, Npo and Npr having a relation Npo<Npr, the cross section perpendicular to the light entrance plane having a concave configuration, the thicknesses of the first layer and the second layer substantially perpendicular to the light exit plane changing individually, the combined particle density in a direction perpendicular to the light entrance plane changing.

### TECHNICAL FIELD

The present invention relates to a light guide plate used for, for example, liquid crystal display devices.

### BACKGROUND ART

Liquid crystal display devices use a backlight unit for emitting light from behind the liquid crystal display panel to illuminate the liquid crystal display panel. A backlight unit is configured using a light guide plate for diffusing light emitted by an illumination light source to illuminate the liquid crystal display panel and optical parts such as a prism sheet and a diffusion sheet for rendering the light emitted from the light guide plate uniform.

Currently, large liquid crystal televisions predominantly use a so-called direct illumination type backlight unit comprising a light guide plate disposed immediately above the illumination light source. This type of backlight unit comprises a plurality of cold cathode tubes serving as a light source provided behind the liquid crystal display panel whereas the inside of the backlight unit provides white reflection surfaces to ensure uniform light amount distribution and necessary luminance.

To achieve a uniform light amount distribution with a direct illumination type backlight unit, however, a thickness of about 30 mm in a direction perpendicular to the liquid crystal display panel is required, making further reduction of thickness of the backlight unit difficult using the direct illumination type backlight unit.

Among backlight units that allow reduction of thickness thereof, on the other hand, is a backlight unit using a light guide plate in which light emitted by an illumination light source and entering the light guide plate is guided in given directions and emitted through a light exit plane that is different from the plane through which light enters.

There has been proposed a backlight unit of a type using a light guide plate in the form of a plate containing scattering particles for diffusing light mixed therein and formed into a transparent resin, whereby light is admitted through the lateral faces of the plate and allowed to exit through the top surface.

Patent Literature 1, for example, discloses a light scattering light guide light source device comprising a light scattering light guide member having at least one light entrance plane region and at least one light exit plane region and light source means for admitting light through the light entrance plane region, the light scattering light guide member having a region that has a tendency to decrease in thickness with the increasing distance from the light entrance plane.

Patent Literature 2 discloses a planar light source device comprising a light scattering light guide member, a prism sheet provided on the side of the light scattering light guide member closer to a light exit plane, and a reflector provided on the rear plane side of the light scattering light guide member. Patent Literature 3 discloses a liquid crystal display comprising a light emission direction correcting element formed of sheet optical materials provided with a light entrance plane having a repeated undulate pattern of prism arrays and a light exit plane given a light diffusing property. Patent Literature 4 discloses a light source device comprising a light scattering light guide member having a scattering power therein and light supply means for supplying light through an end face of the light scattering light guide member.

Also proposed in addition to the above light guide plates are a light guide plate having a greater thickness at the center thereof than at an end thereof at which light is admitted and at the opposite end; a light guide plate having a reflection plane inclined in such a direction that the thickness of the light guide plate increases with the increasing distance from the light admitting portions; and a light guide plate having a configuration such that the distance between the front and the rear plane is smallest at a location at which light is admitted and that the thickness of the light guide plate is greatest at a greatest distance from the location at which light is admitted (See, for example, Patent Literature 5 to 8).

Further, Patent Literature 10 describes an illumination device comprising a light guide plate having a concave light exit plane while Patent Literature 11 describes a light guide plate having a downwardly convex light exit plane (i.e., a concave light exit plane).

Patent Literature 11 describes a two-layer light guide plate having an interface between a first layer and a second layer inclining in a direction to approach the light exit plane as the interface approaches the center of the light guide plate from the ends of the light guide plate (the cross section being an isosceles triangle).

Patent Literature 12 describes a planar light source device having a plate-like body with a portion having at least one non-scattering light guide region overlapping with at least one scattering light guide region made of the same material as the at least one non-scattering light guide region but dispersed with particles having a different refractive index, the distribution of the amount of light exiting through a main plane being controlled by providing the planar light source device with light source lamps on end surfaces and locally adjusting the particle density with the thicknesses of both the regions, wherein the scattering light guide region is formed of a convex light guide block and the non-scattering light guide region is formed of a concave light guide block corresponding to the convex light guide block.

### CITATION LIST

### Patent Literature

Patent Literature 1: JP 7-36037 A
Patent Literature 2: JP 8-248233 A
Patent Literature 3: JP 8-271739 A
Patent Literature 4: JP 11-153963 A
Patent Literature 5: JP 2003-90919 A
Patent Literature 6: JP 2004-171948 A
Patent Literature 7: JP 2005-108676 A
Patent Literature 8: JP 2005-302322 A
Patent Literature 9: JP 8-220346 A
Patent Literature 10: JP 2009-117349 A
Patent Literature 11: JP 2009-117357 A
Patent Literature 12: JP 4127897 B (JP 11-345512 A)

### SUMMARY OF INVENTION

### Technical Problems

While a thin design may be achieved with backlight units such as the tandem type, of which the thickness decreases with the increasing distance from the light source, those backlight units yielded lower light use efficiency than the direct illumination type because of the relative dimensions of the cold cathode tube to the reflector. Further, where the light guide plate used is shaped to have grooves for receiving cold cathode tubes, although such a light guide plate could be shaped to have a thickness that decreases with the increasing distance from the cold cathode tube, luminance at locations above the cold cathode tube disposed in the grooves increased if the light guide plate is made thinner, thus causing uneven luminance on the light exit plane to outstand. In addition, all these light guide plates posed another problem: a complex configuration leading to increased machining costs. Thus, a light guide plate of any of such types adapted to be used for a backlight unit for a large liquid crystal television having a screen size of say 37 inches or larger, in particular 50 inches or larger, was considerably expensive.

Patent Literature 5 to 8 propose light guide plates growing thicker with the increasing distance from the light entrance plane to achieve stabler manufacturing or to limit luminance unevenness (unevenness in light amount) using multiple reflection. These light guide plates, made of a transparent material, allow light admitted from the light source to pass and leak through the opposite end and therefore need to be provided with prisms or dot patterns on the underside thereof.

Also proposed is a method whereby the light guide plate is provided with a reflection member near its light entrance plane on the opposite side from the light entrance plane to cause admitted light to undergo multiple reflection before allowing the light to exit through the light exit plane. To achieve a large light exit plane with these light guide plates by this method, however, the light guide plate needs to have an increased thickness, which increases weight and costs. Another problem is the light sources being projected into the light guide plate and perceived as such to cause uneven luminance and/or uneven illuminance.

The illumination device described in Patent Literature 9, having serration grooves in the reflection surface to provide a scattering surface, needs to have a thick light guide plate to achieve increased dimensions. This increases not only weight but manufacturing costs because of complicated machining required.

While the planar lighting device described in Patent Literature 10 has a light guide plate having a concave light exit plane, the scattering particles are uniformly mixed in the whole light guide plate so that further reducing the thickness was difficult from a viewpoint of optical properties. In addition, because the light entrance plane is small, improving the light use efficiency (light incidence efficiency) was impossible without increasing the weight of the light guide plate.

While, as described above, the light guide plate described in Patent Literature 11 is a two-layer light guide plate having an interface between a first layer and a second layer inclining in a direction to approach the light exit plane as the interface approaches the center of the light guide plate from the ends of the light guide plate so that the cross section is an isosceles triangle, no consideration was given to adjusting the configuration of the second layer to optimize the amount of exiting light.

Likewise, no consideration was given with the planar light source device described in Patent Literature 12 as to adjusting the shape of the scattering light guide region to optimize the amount of exiting light. Further, as ambient temperature and humidity change, a large light guide plate expands and contracts to such an extent that a light guide plate measuring about 50 inches repeats expansion and contraction of 5 mm or more. Therefore, where the light guide plate is a flat plate, whether the light guide plate would warp toward the light exit plane side or the reflection surface side was not to be known. When the light guide plate warps toward the light exit plane side, the light guide plate having undergone expansion and contraction pushes up the liquid crystal panel, causing pool-like irregularities in the light emitted from the liquid crystal display device. To avoid this, one might consider providing a great distance between the liquid crystal display panel and the backlight unit, but this causes a problem that achieving a thin design with a liquid crystal display device is made impossible.

An object of the present invention is to overcome the problems associated with the prior art described above and provide a light guide plate having great dimensions and a flat shape, yielding a high light use efficiency, capable of emitting light with minimized unevenness in luminance and achieving an arched or bell-curve luminance distribution such that a central area of the screen is brighter than the periphery, as required of a flat, large-screen liquid crystal television.

### Solution to Problems

To overcome the above problems, the present invention provides a light guide plate comprising a rectangular light exit plane, at least one light entrance plane provided on a side of the light exit plane for admitting light traveling substantially parallel to the light exit plane, a rear plane provided opposite from the light exit plane, and scattering particles dispersed inside, wherein the light guide plate includes two or more layers lying on each other in a direction substantially perpendicular to the light exit plane and having different densities of the scattering particles, wherein the two or more layers include at least a first layer provided closer to the light exit plane and having the particle density of Npo and a second layer provided closer to the rear plane than the first layer and having the particle density of Npr, a relation between Npo and Npr satisfying Npo<Npr, wherein a cross section lying in a direction from the at least one light entrance plane toward a center of the light exit plane and perpendicular to the at least one light entrance plane has a concave configuration on a side closer to the light exit plane, and wherein thicknesses of the first layer and the second layer in a direction substantially perpendicular to the light exit plane change, and a combined particle density in a direction perpendicular to the light entrance plane changes.

The interface between the first layer and the second layer is preferably curved outward toward the light exit plane in a portion corresponding to a center of the light exit plane in the cross section lying in the direction from the at least one light entrance plane toward the center of the light exit plane and perpendicular to the at least one light entrance plane.

Preferably, the combined particle density is obtained using a reverse bias density and, according to the combined particle density, the thickness of the second layer continuously changes so as to grow thinner from the portion corresponding to the center portion of the light exit plane toward the at least one light entrance plane and grow thicker toward the at least one light entrance plane near the at least one light entrance plane.

Preferably, the light exit plane and the rear plane have a flat configuration, and the concave configuration of the light exit plane side is formed by causing the light guide plate to warp toward the rear plane side.

To overcome the above problems, the present invention provides a light guide plate comprising a rectangular light exit plane, at least one light entrance plane provided on a side of the light exit plane for admitting light traveling substantially parallel to the light exit plane, a rear plane provided opposite from the light exit plane, and scattering particles dispersed inside, wherein the light guide plate includes two or more layers lying on each other in a direction substantially perpendicular to the light exit plane and having different densities of the scattering particles, wherein the two or more layers include at least a first layer provided closer to the light exit plane and having the particle density of Npo and a second layer provided closer to the rear plane than the first layer and having the particle density of Npr, a relation between Npo and Npr satisfying Npo<Npr, wherein a thickness of the second layer continuously changes so as to once grow thinner with an increasing distance from the light entrance plane before starting to grow increasingly thicker.

Preferably, the thickness of the second layer is thickest in the portion corresponding to the central portion of the light exit plane.

Preferably, the interface between the first layer and the second layer is a flat plane, the second layer has a convex configuration on an opposite side from the light exit plane, and the light guide plate includes a third layer having a concave configuration on a side closer to the light exit plane corresponding to the convex configuration of the second layer.

Preferably, the interface between the first layer and the second layer is a plane formed by a curved plane that is concave with respect to the light exit plane on a side closer to one of the light entrance plane connected with a curved plane that is convex with respect to the light exit plane on a side opposite from the light entrance plane.

Preferably, the interface between the first layer and the second layer is a plane formed by a curved plane that is concave with respect to the light exit plane on the one light entrance plane side, a parallel plane that is parallel to the light exit plane on a side opposite from said light entrance plane, and a curved plane that is convex with respect to the light exit plane and connects the concave plane and the parallel plane.

Preferably, the interface between the first layer and the second layer is a plane formed by a curved plane that is concave with respect to the light exit plane on the one light entrance plane side, an inclined plane located on a side opposite from said light entrance plane and inclined with respect to the light exit plane, and a curved plane that is convex with respect to the light exit plane and connects the concave plane and the inclined plane.

Alternatively, the interface between the first layer and the second layer is preferably a plane formed by a curved plane that is concave with respect to the light exit plane on the one light entrance plane side, a curved plane that is located on a side opposite from said light entrance plane and is convex with respect to the light exit plane, and an inclined flat plane that is inclined with respect to the light exit plane and connects the concave plane and the convex plane.

Preferably, the ranges of Npo and Npr satisfy Npo=0 wt % and 0.01 wt %<Npr<0.4 wt %.

Preferably, the ranges of Npo and Npr satisfy 0 wt %<Npo<0.15 wt % and Npo<Npr<0.4 wt %.

Preferably, the rear plane is a flat plane parallel to the light exit plane.

Preferably, the rear plane is a plane so inclined as to be increasingly distant from the light exit plane with the increasing distance from the at least one light entrance plane.

Alternatively, the rear plane is preferably so inclined as to approach the light exit plane with the increasing distance from the light entrance plane.

Preferably, the cross section lying in a direction from the light entrance plane toward the central portion of the light exit plane and perpendicular to the at least one light entrance plane further has a concave configuration also on a side closer to the rear plane.

Preferably, the at least one light entrance plane is provided on a longer side of the light exit plane, and the light entrance plane is provided on one side of the light exit plane.

Preferably, the at least one light entrance plane is two light entrance planes provided on two opposite sides of the light exit plane.

Preferably, the at least one light entrance plane is light entrance planes provided on four sides of the light exit plane.

Preferably, the light guide plate emits light also from the rear plane.

To overcome the above problems, the present invention further provides a planar lighting device comprising any one the light guide plates described above and a light source disposed opposite the at least one light entrance plane.

To overcome the above problems, the present invention further provides a planar lighting device comprising a light guide plate described above and a light source disposed opposite the at least one light entrance plane, wherein the length of a light emission face of the light source in a direction perpendicular to the light exit plane of the light guide plate is 70% or less of a height of the at least one light entrance plane of the light guide plate.

To overcome the above problems, the present invention further provides a liquid crystal display device comprising the planar lighting device described above, a liquid crystal display panel disposed on a side of the planar lighting device closer to the light exit plane of the planar lighting device, and a drive unit for driving the liquid crystal display panel.

### Advantageous Effects of Invention

The present invention enables emission of light offering high light use efficiency and minimized unevenness in luminance with a thin design and achieves an arch-shaped or a so-called bell-curve luminance distribution such that an area close to the center of the screen is brighter than the periphery thereof, as is required of a thin, large-screen liquid crystal television.

Further, according to the present invention, the light guide plate, not easily warping toward the light exit plane, permits reduction in gap between the liquid crystal panel and the light guide plate and thus enables thinner design of the device to be obtained.

Further, the concave configuration of the light exit plane allows a larger light entrance plane to be secured than flat light guide plates having a consistent average thickness and thus a higher light incidence efficiency of light traveling from the light source to be attained. With the area of the light entrance plane being equal, the light guide plate can be made lighter than flat light guide plates.

### BRIEF DESCRIPTION OF DRAWINGS

FIG. 1 is a schematic perspective view illustrating an embodiment of a liquid crystal display device provided with a planar lighting device using the light guide plate according to the invention.

FIG. 2 is a cross sectional view of the liquid crystal display device illustrated in FIG. 1 taken along line II-II.

FIG. 3A is a fragmentary view of the planar lighting device illustrated in FIG. 2 taken along line FIG. 3B is a cross sectional view of FIG. 3A taken along line B-B.

FIG. 4A is a perspective view illustrating a schematic configuration of the light source of the planar lighting device of FIGS. 1 and 2; FIG. 4B is a schematic perspective view illustrating, enlarged, one LED of the light source of FIG. 4A.

FIG. 5 is a perspective view illustrating the shape of the light guide plate of FIG. 3.

FIG. 6 is a graph illustrating measurements of illuminance distributions of light emitted through the light exit plane of the light guide plate.

FIG. 7 is a schematic sectional view illustrating another example of the light guide plate of the invention.

FIG. 8 is a graph illustrating a relation between the size of an LED and efficiency in the light entrance plane of the light guide plate.

FIG. 9 is a schematic sectional view illustrating another example of the light guide plate of the invention

FIG. 10 is a graph illustrating measurements of illuminance distributions of light emitted through the light exit plane of the light guide plate.

FIG. 11 illustrates graphs showing measurements of luminance distributions of light emitted through the light exit plane of the inventive light guide plate.

FIG. 12 illustrates graphs showing measurements of luminance distributions of light emitted through the light exit plane of the inventive light guide plate.

FIG. 13 is a schematic sectional view illustrating another example of the light guide plate of the invention.

FIG. 14 is a graph illustrating measurements of illuminance distributions of light emitted from the light exit plane of the light guide plate.

FIG. 15 is a schematic sectional view illustrating another example of the light guide plate of the invention.

FIG. 16 is a graph illustrating measurements of illuminance distributions of light emitted from the light exit plane of the light guide plate.

FIG. 17 is a graph illustrating measurements of illuminance distributions of light emitted from the light exit plane of the light guide plate.

FIG. 18 is a schematic sectional view illustrating another example of the light guide plate of the invention.

FIG. 19 is a schematic sectional view illustrating another example of the light guide plate of the invention.

FIG. 20 is a schematic sectional view illustrating another example of the light guide plate of the invention.

FIGS. 21A to 21D are schematic sectional views each illustrating a portion of backlight units using other examples of the light guide plate of the invention.

FIG. 22 is a graph illustrating measurements of luminance distributions of light emitted from the light exit plane of the light guide plate.

FIG. 23 is a graph illustrating measurements of luminance distributions of light emitted from the light exit plane of the light guide plate.

FIG. 24 is a schematic sectional view illustrating another example of the light guide plate of the invention.

FIG. 25 is a graph illustrating the thickness of a first layer of the light guide plate of FIG. 24.

FIGS. 26A and 26B are graphs illustrating measurements of illuminance distributions of light emitted from the light exit plane of the light guide plate.

FIGS. 27A and 27B are graphs illustrating measurements of luminance distributions of light emitted from the light exit plane of the light guide plate.

FIG. 28 is a schematic sectional view illustrating an example of a conventional light guide plate.

FIG. 29 is a schematic sectional view illustrating another example of a conventional light guide plate.

### DESCRIPTION OF EMBODIMENTS

Now, a planar lighting device using the light guide plate according to the invention will be described in detail with reference to the preferred embodiments illustrated in the attached drawings.

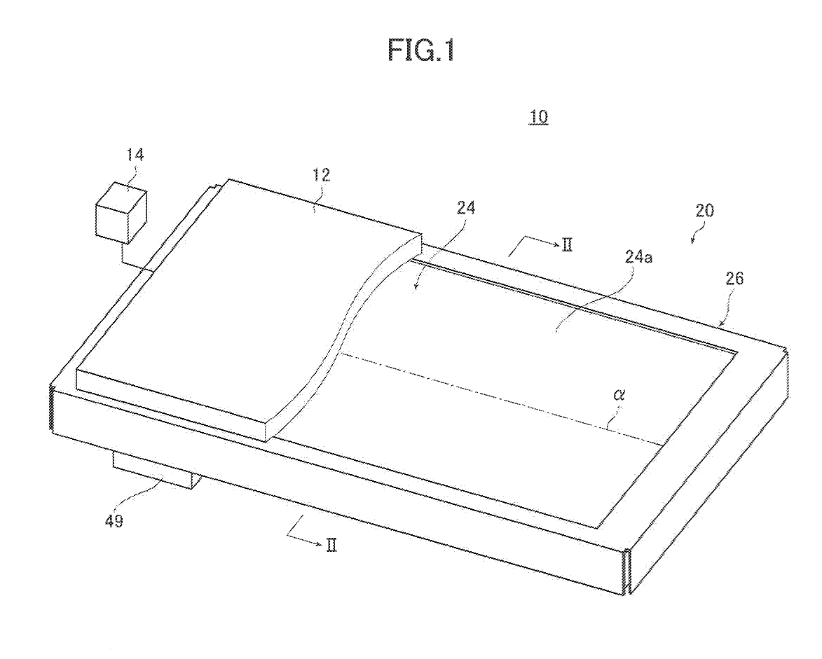

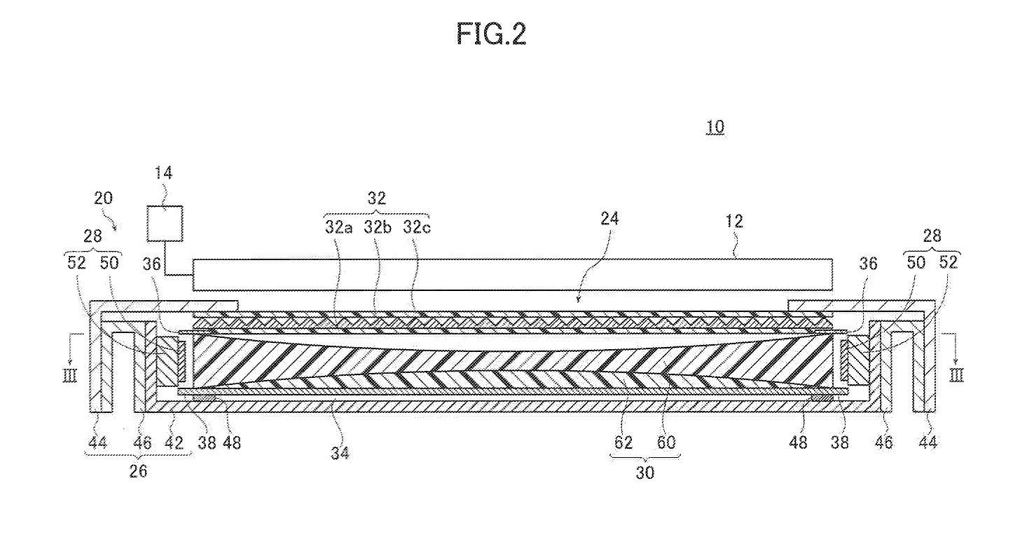

FIG. 1 is a schematic perspective view illustrating a liquid crystal display device provided with a planar lighting device using the light guide plate according to the invention; FIG. 2 is a cross sectional view of the liquid crystal display device illustrated in FIG. 1 taken along line II-II.

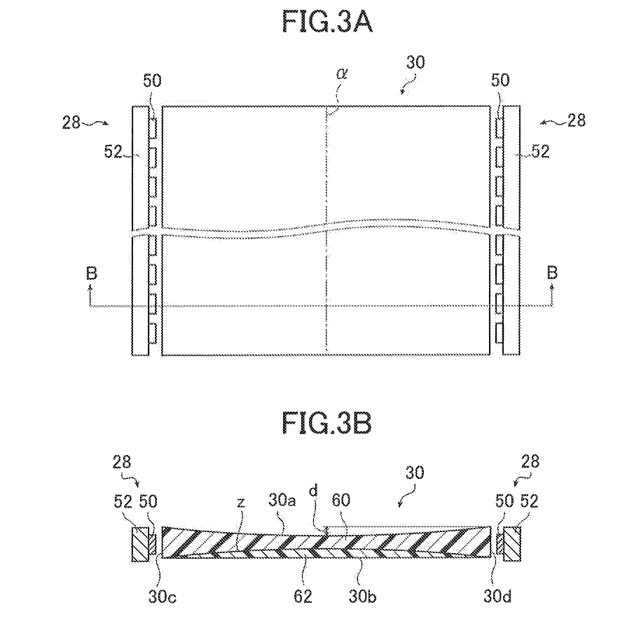

FIG. 3A is a fractional view of the planar lighting device (also referred to as “backlight unit” below) illustrated in FIG. 2 taken along line FIG. 3B is a cross sectional view of FIG. 3A taken along line B-B.

A liquid crystal display device 10 comprises a backlight unit 20, a liquid crystal display panel 12 disposed on the side of the backlight unit closer to the light exit plane, and a drive unit 14 for driving the liquid crystal display panel 12. In FIG. 1, a part of the liquid crystal display panel 12 is not shown to illustrate the configuration of the backlight unit.

In the liquid crystal display panel 12, an electric field is partially applied to liquid crystal molecules, previously arranged in a given direction, to change the orientation of the molecules. The resultant changes in refractive index in the liquid crystal cells are used to display characters, figures, images, etc., on the liquid crystal display panel 12.

The drive unit 14 applies a voltage to transparent electrodes in the liquid crystal display panel 12 to change the orientation of the liquid crystal molecules, thereby controlling the transmittance of the light transmitted through the liquid crystal display panel 12.

The backlight unit 20 is a lighting device for illuminating the whole surface of the liquid crystal display panel 12 from behind the liquid crystal display panel 12 and comprises a light exit plane 24a having substantially the same shape as the image display surface of the liquid crystal display panel 12.

As illustrated in FIGS. 1, 2, 3A and 3B, the backlight unit 20 in this embodiment comprises a main body of the lighting device 24 and a housing 26. The main body of the lighting device 24 comprises two light sources 28, a light guide plate 30, and an optical member unit 32. The housing 26 comprises a lower housing 42, an upper housing 44, turnup members 46, and support members 48. The housing 26 comprises a lower housing 42, an upper housing 44, turnup members 46, and support members 48. As illustrated in FIG. 1, a power unit casing 49 is provided on the underside of the lower housing 42 of the housing 26 to hold power supply units that supply the light sources 28 with electrical power.

Now, component parts constituting the backlight unit 20 will be described.

The main body of the lighting device 24 comprises the light sources 28 for emitting light, the light guide plate 30 for issuing the light emitted from the light sources 28 as planar light, and the optical member unit 32 for scattering and diffusing the light issued from the light guide plate 30 to obtain light with further reduced unevenness.

First, the light sources 28 will be described.

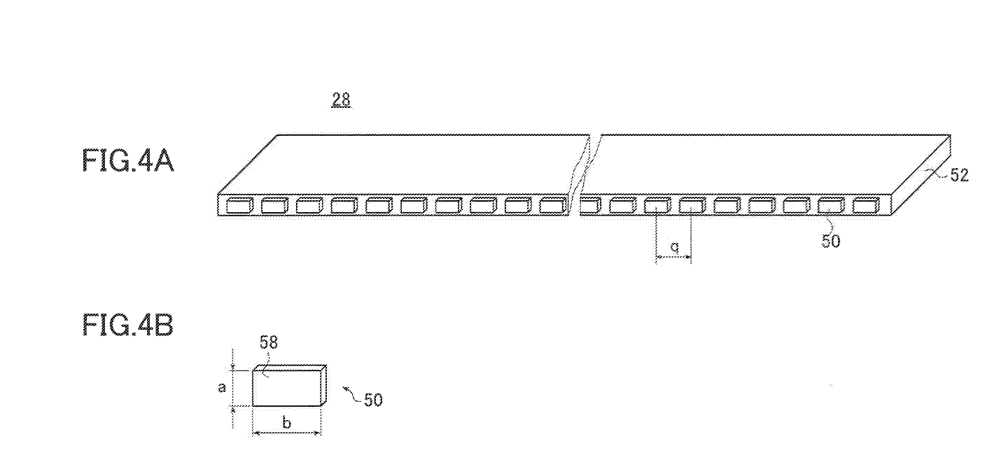

FIG. 4A is a perspective view schematically illustrating a configuration of a light source 28 of the backlight unit 20 of FIGS. 1 and 2; FIG. 4B is a schematic perspective view illustrating, enlarged, only one LED chip of the light source 28 of FIG. 4A.

As illustrated in FIG. 4A, the light source 28 comprises a plurality of light emitting diode chips (referred to as “LED chips” below) 50 and a light source support 52.

The LED chip 50 is a chip of a light emitting diode emitting blue light the surface of which has a fluorescent substance applied thereon. It has a light emission face 58 with a given area through which white light is emitted.

Specifically, when blue light emitted through the surface of the light emitting diode of the LED chip 50 is transmitted through the fluorescent substance, the fluorescent substance generates fluorescence. Thus, the blue light emitted by the light emitting diode and the light emitted as the fluorescent substance fluoresces produce white light from the LED chip 50.

The LED chip 50 may for example be formed by applying a YAG (yttrium aluminum garnet) base fluorescent substance to the surface of a GaN base light emitting diode, an InGaN base light emitting diode, and the like.

Light source supports 52 are plate members disposed such that one surface thereof faces the light entrance plane (30c or 30d).

The light source supports 52 carry the LED chips 50 on their lateral planes facing the light entrance plane (30c or 30d) of the light guide plate 30 so that the LED chips 50 are spaced at given intervals from each other. Specifically, the LED chips 50 constituting the light source 28 are arrayed along the length of a first light entrance plane 30c or a second light entrance plane 30d of the light guide plate 30 to be described, that is, parallel to a line in which the first light entrance plane 30c or the second light entrance plane 30d meets a light exit plane 30a and are secured to the light source support 52.

The light source support 52 is formed of a metal having a good heat conductance as exemplified by copper and aluminum and also acts as a heat sink to absorb heat generated by the LED chips 50 and release the heat to the outside. The light source support 52 may be equipped with fins to provide a larger surface area and an increased heat dissipation effect or heat pipes for transferring heat to a heat dissipation member.

As illustrated in FIG. 4B, the LED chips 50 according to this embodiment each have a rectangular shape such that the sides perpendicular to the direction in which the LED chips 50 are arrayed are shorter than the sides lying in the direction in which the LED chips 50 are arrayed or, in other words, the sides lying in the direction of thickness of the light guide plate 30 to be described, i.e., the direction perpendicular to the light exit plane 30a, are the shorter sides. Thus, the LED chips 50 each have a shape defined by b>a where “a” denotes the length of the side perpendicular to the light exit plane 30a of the light guide plate 30 and “b” denotes the length of the side in the array direction. Now, given “q” as the gap by which the arrayed LED chips 50 are spaced apart from each other, then q>b holds. Thus, the length “a” of the side of the LED chips 50 perpendicular to the light exit plane 30a of the light guide plate 30, the length “b” of the side in the array direction, and the gap “q” by which the arrayed LED chips 50 are spaced apart from each other preferably have a relationship satisfying q>b>a.

Providing the LED chips 50 each having the shape of a rectangle allows a thinner design of the light source to be achieved while producing a large amount of light. Reducing the thickness of the light sources 28, in turn, permits reduction of thickness of the backlight unit. Further, the number of LED chips that need to be arranged may be reduced.

While the LED chips 50 each preferably have a rectangular shape with the shorter sides lying in the direction of the thickness of the light guide plate 30 for a thinner design of the light source 28, the present invention is not limited thereto, allowing the LED chips to have any shape as appropriate such as a square, a circle, a polygon, and an ellipse.

Now, the light guide plate 30 will be described.

FIG. 5 is a perspective view schematically illustrating the shape of the light guide plate.

As illustrated in FIGS. 2, 3A, 3B, and 5, the light guide plate 30 comprises the rectangular light exit plane 30a; two light entrance planes (the first light entrance plane 30c and the second light entrance plane 30d) formed on the two longer sides of the light exit plane 30a and substantially perpendicular to the light exit plane 30a; and a rear plane 30b that is flat and located on the opposite side from the light exit plane 30a, i.e., on the rear side of the light guide plate 30.

The thickness of the light guide plate 30 decreases from the first light entrance plane 30c and the second light entrance plane 30d to the center of the light guide plate (light exit plane 30a) such that the light guide plate 30 is thinnest in a position thereof corresponding to the central bisector a and thickest at the two light entrance planes (the first light entrance plane 30c and the second light entrance plane 30d) on both ends, exhibiting a concave shape. In other words, it is a concave shape symmetrical with respect to the central axis or bisector a connecting the centers of the shorter sides of the light exit plane 30a (see FIGS. 1 and 3).

Described otherwise, it is a concave shape where the light exit plane 30a caves in such that the cross section along a line connecting the first light entrance plane 30c and the second light entrance plane 30d and perpendicular to the light entrance planes in the light guide plate's thickness direction is symmetrical with respect to a line passing through the center of said perpendicular line and intersecting said perpendicular line at right angles in the cross section (a line passing through the center of said perpendicular line in the cross section and parallel to the light entrance planes).

The two light sources 28 mentioned above are disposed opposite the first light entrance plane 30c and the second light entrance plane 30d of the light guide plate 30, respectively. In this embodiment, each light emission face 58 of the LED chips 50 of the light sources 28 has substantially the same length as the first light entrance plane 30c and the second light entrance plane 30d in the direction substantially perpendicular to the light exit plane 30a.

Thus, the backlight unit 20 has the two light sources 28 disposed in such a manner as to sandwich the light guide plate 30. In other words, the light guide plate 30 is placed between the two light sources 28 arranged opposite each other with a given distance between them.

The light guide plate 30 is formed of a transparent resin into which light scattering particles are kneaded and dispersed. Transparent resin materials that may be used to form the light guide plate 30 include optically transparent resins such as PET (polyethylene terephthalate), PP (polypropylene), PC (polycarbonate), PMMA (polymethyl methacrylate), benzyl methacrylate, MS resins, and COP (cycloolefin polymer). The scattering particles kneaded and dispersed into the light guide plate 30 may be formed, for example, of TOSPEARL, silicone, silica, zirconia, or a dielectric polymer.

The cross section along a line connecting the first light entrance plane 30c and the second light entrance plane 30d of the light guide plate 30 and perpendicular to the light entrance planes in the light guide plate's thickness direction is substantially rectangular, and the light exit plane 30a has a concave shape. The structure has two layers, one being a first layer 60 on the side closer to the light exit plane 30a, the other being a second layer 62 closer to the rear plane 30b. An interface z between the first layer 60 and the second layer 62 has a substantially arc-shaped configuration convex toward the light exit plane 30a.

The first layer 60 is a region defined in cross section by the light exit plane 30a, the first light entrance plane 30c, the second light entrance plane 30d, and the interface z; the second layer 62 is a layer adjacent to the first layer on the side closer to the rear plane 30b and a region defined by the interface z and the rear plane 30b.

The concave configuration of the light exit plane 30a is formed of an arc of, for example, a circle having a radius of curvature R of 75000 mm when the screen size measures 42 inches. In this case, the difference between the portion corresponding to the bisector a located at the center of the light exit plane 30a and the end portions of the light exit plane 30a at the first light entrance plane 30c and the second light entrance plane 30d, i.e., an amount of recess d of the concave configuration of the light exit plane 30a, is 0.44 mm.

From a viewpoint of balance between optical characteristics and mechanical characteristics (strength), the radius of curvature R of the concave configuration is preferably in a range of 35000 mm to 185000 mm, and the amount of recess d is preferably 0.1 mm to 0.6 mm. Table 1 shows examples of distance between light entrance planes 30c, 30d, amount of recess d, radius of curvature R, and length of the subtense of the arc of the concave configuration for respective screen sizes. The concave configuration may be an arc of not only a circle but an ellipse or a combination of circle and ellipse or may be an arc near the center of the light exit plane 30a tapering to connect with the first light entrance plane 30c and the second light entrance plane 30d.

TABLE 1

| | Length | | | |
|---|---|---|---|---|
| | between | | | |
| | light | Amount | Radius | |
| Screen | entrance | of | of | Subtense |
| size | planes | recess d | curvature | of arc |
| [inches] | [mm] | [mm] | [mm] | [mm] |
| 32 | 413 | 0.1 | 170000 | 373 |
| | | 0.5 | 35000 | |
| 37 | 480 | 0.1 | 240000 | 440 |
| | | 0.48 | 50000 | |
| 46 | 593 | 0.1 | 380000 | 553 |
| | | 0.51 | 75000 | |
| 65 | 829 | 0.1 | 750000 | 789 |
| | | 0.49 | 160000 | |
| 100 | 1265 | 0.1 | 1850000 | 1225 |
| | | 0.51 | 370000 | |

Although the light guide plate 30 is divided into the first layer 60 and the second layer 62, the first layer 60 and the second layer 62 are both formed of the same transparent resin and containing the same scattering particles dispersed therein, the only difference being the density of the scattering particles. Accordingly, the light guide plate has a one-piece structure. That is, the light guide plate 30 has different particle densities in the respective layers on both sides of the interface z but the interface z is a virtual plane such that the first layer 60 and the second layer 62 are integral with each other.

Now, let Npo be the particle density of the scattering particles in the first layer 60 and Npr the particle density of the scattering particles in the second layer 62. Then Npo and Npr have a relationship expressed by Npo<Npr. Thus, the light guide plate 30 has a higher particle density of scattering particles in the second layer on the side closer to the rear plane 30b than in the first layer on the side closer to the light exit plane 30a.

The light guide plate 30, adapted to contain scattering particles with different densities in different regions thereof, is capable of emitting illumination light having an arched luminance distribution (illuminance distribution) with a minimized unevenness in luminance and illuminance through the light exit plane 30a. The light guide plate 30 so formed may be manufactured by an extrusion molding method or an injection molding method.

The luminance distribution and the illuminance distribution yielded by the light guide plate according to the invention basically share similar tendencies and so do luminance unevenness and illuminance unevenness. Thus, illuminance unevenness is also observed where luminance unevenness appears such that the luminance distribution and the illuminance distribution share similar tendencies.

In the light guide plate 30 illustrated in FIG. 2, light emitted from the light sources 28 and entering the light guide plate 30 through the first light entrance plane 30c and the second light entrance plane 30d is scattered as it travels through the inside of the light guide plate 30 by scatterers (scattering particles) contained inside the light guide plate 30 and, immediately or after being reflected by the rear plane 30b, exits through the light exit plane 30a. Some light may in the process leak through the rear plane 30b. However, it is then reflected by a reflection plate 34 provided on the side of the light guide plate closer to the rear plane 30b to enter the light guide plate 30 again. The reflection plate 34 will be described later in detail.

The shape of the light guide plate such that the thickness of the second layer 62 increases in the direction perpendicular to the light exit plane 30a with the increasing distance from the first light entrance plane 30c or the second light entrance plane 30d opposite which the light sources 28 are disposed allows the light admitted through the light entrance planes 30c and 30d to travel farther from the light entrance planes 30c and 30d and, hence, enables a larger light exit plane 30a to be secured. Moreover, since the light entering through the light entrance planes 30c and 30d is advantageously guided to travel a long distance, a thinner design of the light guide plate 30 is made possible.

The configuration of the light guide plate 30 having different particle densities in the first layer 60 and the second layer 62, respectively, such that the particle density in the first layer 60 located on the side closer to the light exit plane 30a is lower than the particle density in the second layer 62 achieves a more accentuated arched luminance distribution and a higher light use efficiency than in the case of a light guide plate having a single particle density, that is, a light guide plate where particles are dispersed evenly with a uniform density throughout therein.

Specifically, when the relationship between the particle density Npo of the scattering particles in the first layer 60 and the particle density Npr of the scattering particles in the second layer 62 satisfies Npo<Npr as in this embodiment, a combined particle density of the scattering particles gradually increases with the increasing distance from the light entrance planes 30c, 30d toward the center of the light guide plate (toward the center of the two light entrance planes). Accordingly, light reflected by the effects of the scattering particles toward the light exit plane 30a increases with the increasing distance from the light entrance planes 30c, 30d, with the result that an arched illuminance distribution with an optimum proportion can be obtained. In other words, similar effects can be obtained to those produced with a flat light guide plate provided with a scattering particle density distribution in the direction perpendicular to the light entrance planes (light guide plate depth direction). In addition, adjustment of the shape of the interface z permits setting the luminance distribution (scattering particle density distribution) as desired, improving the efficiency to a maximum extent.

The combined particle density herein denotes a density of scattering particles expressed using an amount of scattering particles added (combined) in a direction substantially perpendicular to the light exit plane at a position spaced apart from one light entrance plane toward the other on the assumption that the light guide plate is a flat plate of which the thickness is a thickness at the light entrance planes throughout the light guide plate. In other words, the combined particle density denotes an amount of scattering particles in unit volume or a weight percentage of the scattering particles in relation to the base material added in a direction substantially perpendicular to the light exit plane at a position spaced apart from a light entrance plane on the assumption that the light guide plate is a flat plate having a thickness corresponding to the light entrance planes throughout the light guide plate and having one kind of density.

Further, the light use efficiency can also be substantially as high as or higher than that obtained with a light guide plate having a single kind of particle density. Thus, the light guide plate of the invention is capable of emitting light having an illuminance distribution and a luminance distribution representing a more accentuated arched curve than the light guide plate having a single particle density while keeping the light use efficiency substantially as high as that achieved by the light guide plate having a single kind of particle density. In addition, since the layer closest to the light exit plane has a low particle density, the amount of the overall scattering particles used can be smaller than otherwise, leading to reduced manufacturing costs.

It is preferable that the relationship between the particle density Npo of the scattering particles in the first layer 60 and the particle density Npr of the scattering particles in the second layer 62 satisfies 0 wt %<Npo<0.15 wt % and Npo<Npr<0.4 wt %.

With the first layer 60 and the second layer 62 of the light guide plate 30 satisfying the above relationships, the first layer 60 having a lower particle density guides the incoming light deep into the light guide plate 30 (toward the center thereof) without scattering the light greatly, the admitted light being scattered by the second layer 62 as the light comes closer to the center of the light guide plate 30, thus increasing the amount of light emitted through the light exit plane 30a. In brief, an illuminance distribution representing an arched curve with an optimum proportion can be achieved while the light use efficiency is further enhanced.

The particle density [wt %] herein denotes a ratio of the weight of the scattering particles to the weight of the base material.

It is also preferable that the particle density Npo of the scattering particles in the first layer 60 and the particle density Npr of the scattering particles in the second layer 62 satisfy Npo=0 wt % and 0.001 wt %<Npr<0.4 wt %. Thus, the scattering particles are not dispersed in the first layer 60 to guide the admitted light deep in the light guide plate 30, and the scattering particles are dispersed only in the second layer 62 so that the light is scattered more as it approaches the center of the light guide plate, thereby increasing the amount of light emitted through the light exit plane 30a.

The particle density Npo of the scattering particles in the first layer 60 and the particle density Npr of the scattering particles in the second layer 62 adapted to satisfy the above relationship enable an illuminance distribution representing an arched curve with an optimum proportion to be achieved while further enhancing the light use efficiency.

There is no specific limitation to the thickness of the light guide plate of the invention; the light guide plate may have a thickness of several millimeters or may be one in the form of a film or a so-called light guide sheet having a thickness of 1 mm or less. A light guide plate in the form of a film comprising two layers each containing scattering particles with different particle densities may be produced as follows: a base film containing scattering particles is fabricated by extrusion molding or like method to provide the first layer; a monomeric resin liquid (transparent resin liquid) having scattering particles dispersed therein is applied to the base film, which base film is then irradiated with ultraviolet light or visible light to harden the monomeric resin liquid, thereby fabricating the second layer having a desired particle density to produce a light guide plate in the form of a film. Other alternatives include a two-layer extrusion molding method.

Where the light guide plate is a light guide sheet in the form of a film having a thickness of 1 mm or less, the light guide plate, when given a two-layer configuration, still makes it possible to achieve an illuminance distribution representing an arched curve with an optimum proportion while further enhancing the light use efficiency.

Next, the optical member unit 32 will be described.

The optical member unit 32 is provided to reduce the luminance unevenness and illuminance unevenness of the illumination light emitted through the light exit plane 30a of the light guide plate 30 before emitting the light through the light exit plane 24a of the main body of the lighting device 24. As illustrated in FIG. 2, the optical member unit 32 comprises a diffusion sheet 32a for diffusing the illumination light emitted through the light exit plane 30a of the light guide plate 30 to reduce luminance unevenness and illuminance unevenness; a prism sheet 32b having micro prism arrays formed thereon parallel to the lines where the light exit plane 30a and the light entrance planes 30c, 30d meet; and a diffusion sheet 32c for diffusing the illumination light emitted through the prism sheet 32b to reduce luminance unevenness and illuminance unevenness.

There is no specific limitation to the diffusion sheets 32a and 32c and the prism sheet 32b; known diffusion sheets and a known prism sheet may be used. For example, use may be made of the diffusion sheets and the prism sheets disclosed in paragraphs [0028] through [0033] of JP 2005-234397 A by the Applicant of the present application.

While the optical member unit in this embodiment comprises the two diffusion sheets 32a and 32c and the prism sheet 32b between the two diffusion sheets, there is no specific limitation to the order in which the prism sheet and the diffusion sheets are arranged or the number thereof to be provided. Nor are the prism sheet and the diffusion sheets specifically limited, and use may be made of various optical members, provided that they are capable of reducing the unevenness in luminance and illuminance of the illumination light emitted through the light exit plane 30a of the light guide plate 30.

For example, the optical members may also be formed of transmittance adjusting members each comprising a number of transmittance adjusters consisting of diffusion reflectors distributed according to the luminance unevenness, and the illuminance unevenness in addition to or in place of the diffusion sheets and the prism sheet described above. Further, the optical member unit may be adapted to have a two-layer structure formed using one sheet each of the prism sheet and the diffusion sheet or two diffusion sheets only.

Now, the reflection plate 34 of the main body of the lighting device 24 will be described.

The reflection plate 34 is provided to reflect light leaking through the rear plane 30b of the light guide plate 30 back into the light guide plate 30 and helps enhance the light use efficiency. The reflection plate 34 has a shape corresponding to the rear plane 30b of the light guide plate 30 and is formed so as to cover the rear plane 30b. In this embodiment, since the rear plane 30b of the light guide plate 30 is formed into a flat plane, i.e., a straight line in cross section as illustrated in FIG. 2, the reflection plate 34 has a shape contouring that profile.

The reflection plate 34 may be formed of any material as desired, provided that it is capable of reflecting light leaking through the rear plane 30b of the light guide plate 30. The reflection plate 34 may be formed, for example, of a resin sheet produced by kneading, for example, PET or PP (polypropylene) with a filler and then drawing the resultant mixture to form voids therein for increased reflectance; a sheet with a specular surface formed by, for example, depositing aluminum vapor on the surface of a transparent or white resin sheet; a metal foil such as an aluminum foil or a resin sheet carrying a metal foil; or a thin sheet metal having a sufficient reflective property on the surface.

Upper light guide reflection plates 36 are disposed between the light guide plate 30 and the diffusion sheet 32a, i.e., on the side of the light guide plate 30 closer to the light exit plane 30a, covering the light sources 28 and the end portions of the light exit plane 30a, i.e., the end portion thereof closer to the first light entrance plane 30c and the end portion thereof closer to the second light entrance plane 30d. Thus, the upper light guide reflection plates 36 are disposed to cover an area extending from part of the light exit plane 30a of the light guide plate 30 to a part of the light source support 52 of the light sources 28 in a direction parallel to the direction of the optical axis. Briefly, two upper light guide reflection plates 36 are disposed respectively at both end portions of the light guide plate 30.

The upper light guide reflection plates 36 thus provided prevent light emitted by the light sources 28 from failing to enter the light guide plate 30 and leaking toward the light exit plane 30a.

Thus, light emitted from the light sources 28 can be efficiently admitted through the first light entrance plane 30c and the second light entrance plane 30d of the light guide plate 30, increasing the light use efficiency.

Lower light guide reflection plates 38 are disposed on the side of the light guide plate 30 closer to the rear plane 30b so as to cover a part of the light sources 28. The ends of the lower light guide reflection plates 38 closer to the center of the light guide plate 30 are connected to the reflection plate 34.

The upper light guide reflection plates 36 and the lower light guide reflection plates 38 may be formed of any of the above-mentioned materials used for the reflection plate 34.

The lower light guide reflection plates 38 thus provided prevent light emitted by the light sources 28 from failing to enter the light guide plate 30 and leaking toward the rear plane 30b of the light guide plate 30.

Thus, light emitted from the light sources 28 can be efficiently admitted through the first light entrance plane 30c and the second light entrance plane 30d of the light guide plate 30, increasing the light use efficiency.

While the reflection plate 34 is connected to the lower light guide reflection plates 38 in the embodiment under discussion, their configuration is not limited thereto; they may be formed of separate materials.

The shapes and the widths of the upper light guide reflection plates 36 and the lower light guide reflection plates 38 are not specifically limited, provided that light emitted by the light sources 28 is reflected and directed toward the first light entrance plane 30c or the second light entrance plane 30d such that light emitted by the light sources 28 can be admitted through the first light entrance plane 30c or the second light entrance plane 30d and then guided toward the center of the light guide plate 30.

While, in the embodiment under discussion, the upper light guide reflection plates 36 are disposed between the light guide plate 30 and the diffusion sheet 32a, the location of the upper light guide reflection plates 36 is not so limited; they may be disposed between the sheets constituting the optical member unit 32 or between the optical member unit 32 and the upper housing 44.

Next, the housing 26 will be described.

As illustrated in FIG. 2, the housing 26 accommodates and supports therein the main body of the lighting device 24 by clamping the light guide plate from both sides thereof one facing the light exit plane 24a and the other facing the rear plane 30b to secure the main body of the lighting device 24. The housing 26 comprises the lower housing 42, the upper housing 44, the turnup members 46, and the support members 48.

The lower housing 42 is open at the top and has a configuration comprising a bottom portion and lateral portions provided upright on the four sides of the bottom portion. In brief, it has the shape of a box open on one side in the form of substantially a rectangular parallelepiped. As illustrated in FIG. 2, the lower housing 42 supports the main body of the lighting device 24 placed therein from above on the underside and on the lateral sides so as to cover the faces of the main body of the lighting device 24 except the light exit plane 24a, i.e., the plane opposite from the light exit plane 24a of the main body of the lighting device 24 (rear plane) and the lateral sides.

The upper housing 44 has the shape of a rectangular box; it has an opening at the top smaller than the rectangular light exit plane 24a of the main body of the lighting device 24 and is open on the bottom side.

As illustrated in FIG. 2, the upper housing 44 is placed from above the main body of the lighting device 24 and the lower housing 42, that is, from the light exit plane side, to cover the main body of the lighting device 24 and the lower housing 42, which holds the former, as well as four lateral sections.

The turnup members 46 have a substantially U-shaped sectional profile that is identical throughout their length. That is, each turnup member 46 is a bar-shaped member having a U-shaped profile in cross section perpendicular to the direction in which it extends.

As illustrated in FIG. 2, the turnup members 46 are fitted between the lateral sections of the lower housing 42 and the lateral sections of the upper housing 44 such that the outer face of one of the parallel sections of the U shape connects with a lateral section of the lower housing 42 whereas the outer face of the other parallel section connects with a lateral section of the upper housing 44.

To connect the lower housing 42 with the turnup members 46 and the turnup members 46 with the upper housing 44, any known method may be used such as a method using bolts and nuts and a method using bonds.

Thus providing the turnup members 46 between the lower housing 42 and the upper housing 44 increases the rigidity of the housing 26 and prevents the light guide plate 30 from warping. As a result, for example, light can be efficiently emitted without, or with a minimized level of, luminance unevenness or illuminance unevenness. Further, even where the light guide plate used is liable to develop a warp, the warp can be corrected more infallibly or the warping of the light guide plate can be prevented more infallibly, thereby allowing light to be emitted through the light exit plane without luminance unevenness or with a greatly reduced level of luminance unevenness.

The upper housing, the lower housing, and the turnup members of the housing may be formed of various materials such as metals and resins. The material used is preferably lightweight and strong.

While the turnup members are discretely provided in the embodiment under discussion, they may be integrated with the upper housing or the lower housing. Alternatively, the configuration may be formed without the turnup members.

The support members 48 are rod members each having an identical cross section perpendicular to the direction in which they extend throughout their length.

As illustrated in FIG. 2, the support members 48 are provided between the reflection plate 34 and the lower housing 42, more specifically, between the reflection plate 34 and the lower housing 42 close to the end of the rear plane 30b of the light guide plate 30 on which the first light entrance plane 30c is located and close to the end of the light guide plate 30 on which the second light entrance plane 30d is provided. The support members 48 thus secure the light guide plate 30 and the reflection plate 34 to the lower housing 42 and support them.

With the support members 48 supporting the reflection plate 34, the light guide plate 30 and the reflection plate 34 can be brought into a close contact. Furthermore, the light guide plate 30 and the reflection plate 34 can be secured to a given position in the lower housing 42.

While the support members are discretely provided in this embodiment, the invention is not limited thereto; they may be integrated with the lower housing 42 or the reflection plate 34. To be more specific, the lower housing 42 may be adapted to have projections to serve as support members or the reflection plate 34 may be adapted to have projections to serve as support members.

The locations of the support members are also not specifically limited and they may be located anywhere between the reflection plate and the lower housing. To stably hold the light guide plate, the support members are preferably located closer to the ends of the light guide plate or, in this embodiment, near the first light entrance plane 30c and the second light entrance plane 30d.

The support members 48 may be given various shapes and formed of various materials without specific limitations. For example, a plurality of support members may be provided at given intervals.

Further, the support members may have such a shape as to fill the space formed by the reflection plate and the lower housing. Specifically, the support members may have a shape such that the side thereof facing the reflection plate has a profile contouring the surface of the reflection plate and the side thereof facing the lower housing has a profile contouring the surface of the lower housing. Where the support members are adapted to support the whole surface of the reflection plates, separation of the light guide plate and the reflection plate can be infallibly prevented and, further, generation of luminance unevenness and illuminance unevenness that might otherwise be caused by light reflected by the reflection plate can be prevented.

The backlight unit 20 is basically configured as described above.

In the backlight unit 20, light emitted by the light sources 28 provided on both sides of the light guide plate 30 strikes the light entrance planes (the first light entrance plane 30c and the second light entrance plane 30d) of the light guide plate 30. Then, the light admitted through the respective planes is scattered by scatterers contained inside the light guide plate 30 as the light travels through the inside of the light guide plate 30 and, directly or after being reflected by the rear plane 30b, is emitted through the light exit plane 30a. In the process, part of the light leaking through the rear plane is reflected by the reflection plate 34 to enter the light guide plate 30 again.

Thus, light emitted through the light exit plane 30a of the light guide plate 30 is transmitted through the optical members 32 and emitted through the light exit plane 24a of the main body of the lighting device 24 to illuminate the liquid crystal display panel 12.

The liquid crystal display panel 12 displays, for example, characters, figures, and images on its surface as the drive unit 14 controls the transmittance for the light according to the position.

Now, the planar lighting device 20 will be described in greater detail with reference to specific examples.

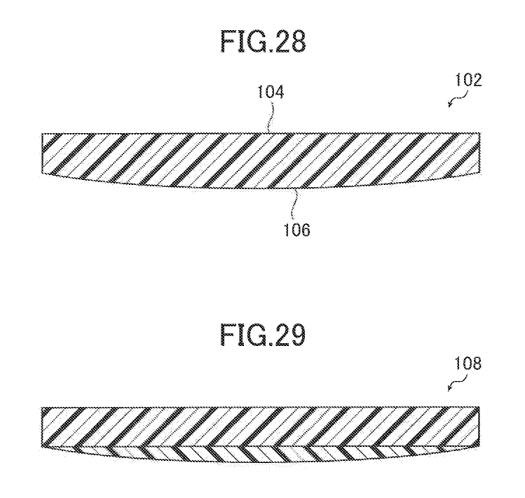

In this embodiment, a computer simulation was conducted on a one-layer light guide plate (having a configuration having a flat light exit plane and a rear plane curved toward the rear side; see FIG. 28) and a two-layer and a three-layer light guide plate to obtain normalized illuminance distributions of emitted light.

In the simulated model of the light guide plate, the transparent resin material was PMMA and the material of scattering particles was silicone. This will also apply to all the examples given below.

### Example 1

Example 1 used the light guide plate 30 corresponding to a 42-inch screen. Specifically, the light guide plates used had a following configuration: the length from the first light entrance plane 30c to the second light entrance plane 30d was 545 mm; the length from the light exit plane 30a to the rear plane 30b at the bisector α, i.e., the thickness D of the thinnest portion, was 2.56 mm; the thickness of the light guide plate at the first light entrance plane 30c and the second light entrance plane 30d, i.e., the maximum thickness of the light guide plate, was 3.0 mm; the length of the first layer 60 from the light exit plane 30a to the interface z at the bisector α, i.e., the thickness D1 of a portion of the first layer 60 where the first layer 60 is thinnest, was 2.12 mm; the length of the second layer 62 from the interface z to the rear plane 30b at the bisector α, i.e., the thickness D2 of a portion of the second layer 62 where the second layer 62 is thickest, was 0.44 mm; the radius of curvature R of the light exit plane 30a was 75000 mm, and the amount of recess d was 0.44 mm. The scattering particles kneaded and dispersed into the light guide plate had a diameter of 4.5 μm.

Using the light guide plates having the above configuration, measured were the illuminance distribution in Example 11 where the first layer 60 had a particle density Npo of 0.02 wt % and the second layer 62 had a particle density Npr of 0.10 wt % and the illuminance distribution in Example 12 where the first layer 60 had a particle density Npo of 0.02 wt % and the second layer 62 had a particle density Npr of 0.15 wt %. Measurements were also made of a light guide plate 102 in Comparative Example 11 where both the first layer 60 and the second layer 62 had a particle density of 0.05 wt %, so that the whole light guide plate had a consistent particle density and hence had a single layer having a shape as illustrated in FIG. 28. The light guide plate 102 in Comparative Example 11 had a configuration having a flat light exit plane 104 and a rear plane 106 having a convex configuration curved outwardly toward the rear plane.

Because the area where measured luminance increases steeply near where light is admitted is provided with a cover reflection member in actual use, light responsible for such a steep increase in the measured luminance, not emitted through the light exit plane of the planar lighting device, causes no luminance unevenness perceived and is thus not recognized as light emitted through the light exit plane, so that such light was disregarded. This will also apply to the examples given below.

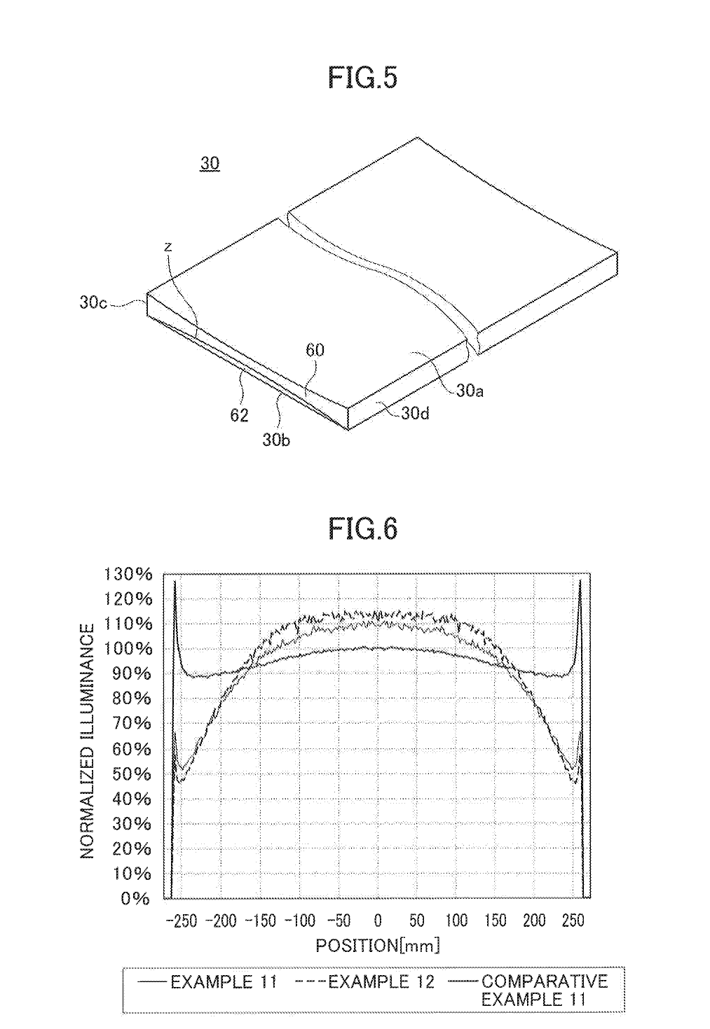

Table 2 shows measurements of illuminance; FIG. 6 illustrates normalized illuminance distributions. In FIG. 6, the vertical axis indicates normalized illuminance; the horizontal axis indicates distance [mm] from the center of the light guide plate. In the graph, Example 11 is indicated in a fine solid line, Example 12 in a broken line, and Comparative Example 11 in a thick solid line.

TABLE 2

| 42 inches | | Ex. 11 | Ex. 12 | Com. Ex. 11 |
|---|---|---|---|---|
| Light entrance plane thickness (mm) | | 3 | 3 | 1.6 |
| Central portion thickness (mm) | | 2.56 | 2.56 | 3.43 |
| Particle | First layer | 0.02 | 0.02 | 0.05 |
| density (wt %) | Second layer | 0.1 | 0.15 | |

| | | | |
|---|---|---|---|
| Normalized illuminance (%) | 110 | 113 | 100 |

As illustrated in FIG. 6 and Table 2, the light guide plates in Examples 11 and 12 have an improved illuminance in the central area by 10% or more over the single-layer light guide plate 102 having a consistent particle density and a shape as illustrated in FIG. 28. Further, the light guide plates in Examples 11 and 12 exhibit illuminance distributions that are more conspicuously arched than those of Comparative Example 11 as illustrated in FIG. 6.

A description is now made of a relation between thickness of the light entrance planes and light incidence efficiency.

FIG. 8 illustrates variations in light incidence efficiency depending on the size of light source LEDs in light guide plates having different configurations for 40-inch screen size.

Measurements were taken of the light incidence efficiency of a two-layer light guide plate in Example 101 having the same configuration as the light guide plate 30 illustrated in FIG. 2 but modified only in size for a 40-inch screen such that the light entrance planes have a thickness of 2.62 mm in a direction substantially perpendicular to the light exit plane. Measurements were also made of light incidence efficiency of a single-layer light guide plate in Comparative Example 101 having a shape as illustrated in FIG. 28 where the light entrance planes had a thickness of 1.50 mm and the whole light guide plate had a consistent particle density; a two-layer light guide plate 108 in Comparative Example 102 having a shape as illustrated in FIG. 29 and having different particle densities where the light entrance planes had a thickness of 1.96 mm; and a two-layer light guide plate having a flat shape in Comparative Example 103 where the light entrance planes had a thickness of 2.29 mm, the two layers having different particle densities. The distance between the LED light emitting surfaces and the light entrance planes of the light guide plate is 0.2 mm.

In FIG. 8, the vertical axis shows the normalized efficiency, and the horizontal axis shows the size of the LED light emitting surface. Black triangles show Example 101, black rhombuses show Comparative Example 101, black rectangles show Comparative Example 102, and asterisks show Comparative Example 103.

As illustrated in FIG. 8, when the LEDs used have a light emitting surface of a height smaller than the thickness of the light entrance planes, the light incidence efficiency is 95% or more, whereas when the LEDs used are of large dimensions such that the dimension of the light emitting surface in the height direction is greater than the thickness of the light entrance planes of the light guide plate in order to increase the amount of light of the light source, the light incidence efficiency steeply decreases. Therefore, in order to use large LEDs producing a large amount of light, it is important that the light entrance planes of the light guide plate have a great thickness.

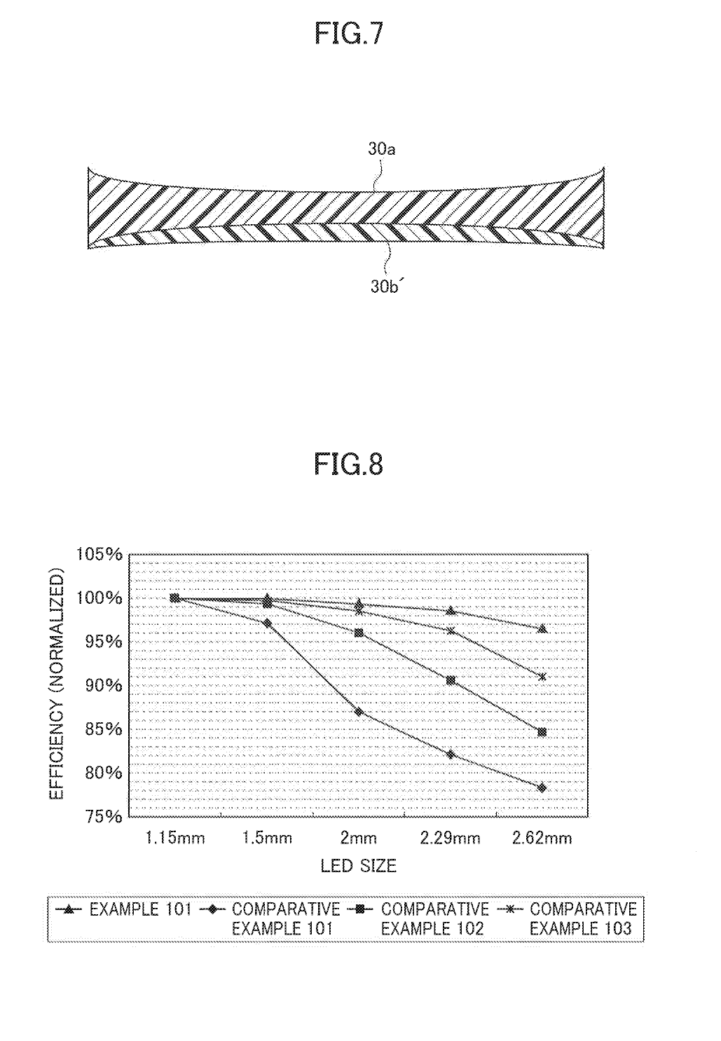

As a variation of Example 1, the light guide plate may have a rear plane 30b′ curved toward the light exit plane side (that is, caved on the rear plane side) as illustrated in FIG. 7. In this case, the radius of curvature R of the concave configuration of the rear plane 30b′ is preferably in a range of 150000 mm to 1850000 mm from a viewpoint of balance between optical characteristics and mechanical characteristics (mechanical strength). The concave configuration may be an arc of not only a circle but an ellipse or a combination of circle and ellipse or may be an arc near the center of the light exit plane 30a then tapering to connect with the first light entrance plane 30c and the second light entrance plane 30d.

Table 3 shows examples of radii of the arcs forming the concave configuration of the light exit plane and the concave configuration of the rear plane for respective screen sizes.

TABLE 3

| | Screen size (inches) | | |
|---|---|---|---|
| | 37 | 46 | 100 |
| Light exit plane side radius R1 | 60000 | 75000 | 175000 |
| (mm) | | | |
| Rear plane side radius R1 (mm) | 250000 | 350000 | 750000 |

The light guide plates having a concave light exit plane and composed of two layers having different particle densities as described above (Examples 11, 12, and 101) allow larger light entrance planes to be secured than the light guide plates illustrated in FIGS. 28 and 29, hence enhance the light incidence efficiency, so that an arched illuminance distribution can be obtained.

Further, since larger light entrance planes can be secured than with flat light guide plates having a consistent average thickness, the light incidence efficiency can be increased, and hence the weight of the light guide plate can be reduced. In addition, an arched illuminance distribution can be obtained.

### Example 2

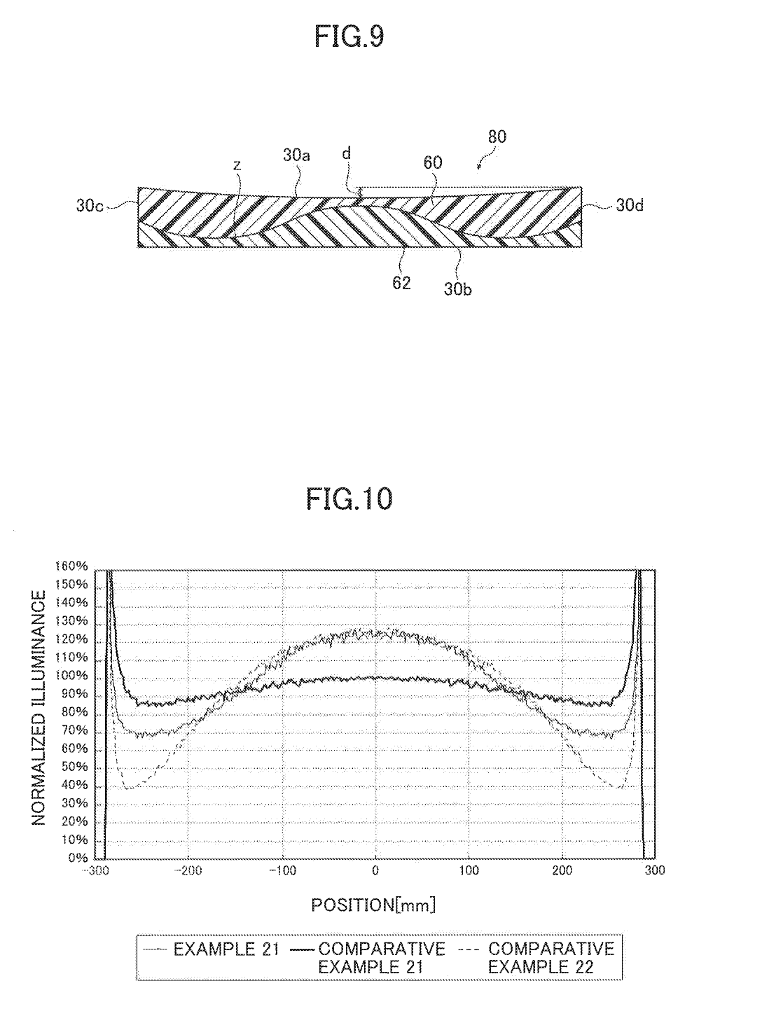

Example 2 used a light guide plate 80 for a screen size of 46 inches having substantially the same external shape as Example 1, where, as illustrated in FIG. 9, the interface z between the first layer 60 and the second layer 62 continuously changes so that the second layer 62 grows thinner from the bisector a of the light exit plane 30a (i.e., center of the light exit plane) toward the first light entrance plane 30c and the second light entrance plane 30d, thereafter growing thicker toward the light exit plane 30a near the first light entrance plane 30c and the second light entrance plane 30d. Here, a reverse bias density was used to obtain a combined particle density, and the thicknesses of the first layer 60 and the second layer 62 (configuration of the interface z) were obtained according to the obtained combined particle density.

Thus, the profile of the combined particle density peaks at the center of the light guide plate 30 and reaches a minimum at points on both sides thereof that are located at about ⅔ of the distance from the center to the light entrance planes (30d and 30e) in the illustrated example.

The reverse bias density refers to a method applied particularly to an arch-shaped light guide plate having a thickness growing thinner toward the center thereof and denotes a particle density (distribution) obtained by obtaining an illuminance distribution (luminance distribution) yielded by a light guide plate containing no particles and multiplying the combined density by a constant to flatten the obtained distribution.

To obtain a reverse bias density, an illuminance distribution (luminance distribution) of light emitted from the light guide plate is first obtained with no particles contained in the light guide plate. When the light guide plate has a thickness growing increasingly thinner toward the center thereof, an illuminance distribution (luminance distribution) caved in the middle is obtained. Next, the difference of this illuminance distribution from a flat distribution is obtained and multiplied by a constant in each unit volume in the light guide plate depth direction to obtain a particle density for each unit volume as reverse bias density. The reverse bias density is then used to obtain the cross sectional configuration of the two-layer light guide plate. Further obtained is a desired arched particle density distribution obtained from the flat two-layer light guide plate, which particle density distribution is converted into the cross sectional configuration of the two-layer light guide plate. Lastly, the two-layer cross-sectional configuration obtained from the reverse bias density distribution is added to the two-layer cross-sectional configuration obtained from the flat plate to obtain a desired two-layer cross-sectional configuration.

The light guide plate 80 has a following configuration: the length of the first layer 60 from the light exit plane 30a to the interface z at the bisector α, i.e., the thickness D1 of the first layer 60, is 0.25 mm; the length of the second layer 62 from the interface z to the rear plane 30b at the bisector α, i.e., the thickness D2 of the second layer 62 is 0.75 mm; the thickness of the light entrance planes (30c, 30d) is 1.5 mm; a thickness D2′ of the second layer 62 at the first light entrance plane 30c and the second light entrance plane 30d is 0.2 mm; the radius of curvature R of the light exit plane 30a is 75000 mm; and the amount of recess d is 0.5 mm. The scattering particles kneaded and dispersed into the light guide plate had a diameter of 7 μm.

Measurements were taken of the illuminance distribution of a light guide plate in Example 21 having the above configuration where the first layer had a particle density Npo of 0.02 wt % and the second layer 62 had a particle density Npr of 0.10 wt %. Measurements were also made of a one-layer light guide plate in Comparative Example 21 having the configuration as illustrated in FIG. 28 where both the first layer 60 and the second layer 62 had a particle density of 0.05 wt %, that is, the whole light guide plate had a consistent particle density and a flat two-layer light guide plate in Comparative Example 22 having the second layer on the rear plane side curved toward the light exit plane side, where the first layer had a particle density Npo of 0 wt % and the second layer had a particle density Npr of 0.07 wt %. The light guide plate 102 in Comparative Example 21 has a flat light exit plane 104 and a rear plane 106 curved toward the rear side.

FIG. 10 illustrates normalized illuminance distributions as obtained from measurements taken of the illuminance. In FIG. 10, the vertical axis indicates normalized illuminance, and the horizontal axis indicates distance [mm] from the center of the light guide plate. In the graph, Example 21 is indicated in a thin solid line, Comparative Example 21 in a thick solid line, and Comparative Example 22 in a broken line.

As illustrated in FIG. 10, the light guide plate in Example 21 has a central luminance that is improved by 20% or more over the light guide plate in Comparative Example 21. Further, the illuminance near the light entrance planes is improved over Comparative Example 22. Because the film structure is composed of a diffusion film, a prism sheet, and a diffusion film, and hence the luminance is proportional to the illuminance, it may be said that the luminance is improved.

The light guide plate as described above (Example 21) having a concave light exit plane and the second layer, out of two layers having different particle densities, optimized with a reverse bias density has an illuminance improved near the light entrance planes over the light guide plates in Examples 11 and 12 and exhibits a still more desirable arched illuminance distribution.

In the light guide plate 80 illustrated in FIG. 9, the interface z between the first layer 60 and the second layer 62, as seen in cross section perpendicular to the longitudinal direction of the light entrance planes, exhibits a curved plane caved in with respect to the light exit plane 30a near the first light entrance plane 30c and the second light entrance plane 30d and a curved plane bulged toward the light exit plane 30a in a region near the center of the light guide plate 80.

The concave and convex curved plane forming the interface z may be a curve that is a part of a circle or an ellipse in a cross section perpendicular to the longitudinal direction of the light entrance planes or may be a curve of second order or a curve expressed by a polynomial or a curve formed by a combination thereof.

When the concave and convex curved plane forming the interface z is formed of a part of a circle, it is preferable that a radius of curvature R_{y1} of the concave plane is in a range of 2500 mm≦R_{y1}≦110000 mm and a radius of curvature R_{y2} of the convex plane is in a range of 2500 mm≦R_{y2}≦120000 mm for a light guide plate corresponding to a screen size of 32 inches; the radius of curvature R_{y1} of the concave plane is in a range of 2500 mm≦R_{y1}≦230000 mm and a radius of curvature R_{y2} of the convex plane is in a range of 2500 mm≦R_{y2}≦250000 mm for a light guide plate corresponding to a screen size of 46 inches; and the radius of curvature R_{y1} of the concave plane is in a range of 5000 mm≦R_{y1}≦450000 mm and a radius of curvature R_{y2} of the convex plane is in a range of 5000 mm≦R_{y2}≦490000 mm for a light guide plate corresponding to a screen size of 65 inches.

### Example 3

In Example 3, measurements were taken of the light guide plate 80 illustrated in FIG. 9 for a screen size of 32 inches as the radii of curvature R_{y1} and R_{y2} of the concave and convex plane forming the interface z and the particle densities of the first layer 60 and the second layer 62 were changed.

Specifically, Example 3 used a light guide plate such that the length from the first light entrance plane 30c to the second light entrance plane was 413 mm, the thickness of the first light entrance plane 30c and the second light entrance plane 30d, i.e., the thickness D2 of the thickest portion was 3 mm, the amount of recess d was 0.5 mm, the radius of curvature of the light exit plane 30a was 42500 mm, a thickness D3 of the second layer 62 at the first light entrance plane was 0.5 mm, a thickness D4 of the thinnest portion of the second layer 62 was 0.48 mm, and a thickness D5 of the thickest portion of the second layer 62 was 1.0 mm. The scattering particles kneaded and dispersed into the light guide plate had a particle diameter of 4.5 μm.

The above light guide plate was used to measure the illuminance distribution in Example 31, where the radius of curvature R_{y1} of the concave plane of the interface z was 2500 mm, the radius of curvature R_{z2} of the convex plane was 35000 mm, the particle density Npo of the first layer 60 was 0.003 wt %, and the particle density Npr of the second layer 62 was 0.125 wt %; Example 32, where the radius of curvature R_{y1} of the concave plane of the interface z was 2500 mm, the radius of curvature R_{z2} of the convex plane was 35000 mm, the particle density Npo of the first layer 60 was 0.003 wt %, and the particle density Npr of the second layer 62 was 0.15 wt %; Example 33, where the radius of curvature R_{y1} of the concave plane of the interface z was 30000 mm, the radius of curvature R_{z2} of the convex plane was 2500 mm, the particle density Npo of the first layer 60 was 0.003 wt %, and the particle density Npr of the second layer 62 was 0.125 wt %; Example 34, where the radius of curvature R_{y1} of the concave plane of the interface z was 30000 mm, the radius of curvature R_{z2} of the convex plane was 2500 mm, the particle density Npo of the first layer 60 was 0.003 wt %, and the particle density Npr of the second layer 62 was 0.15 wt %; and Example 35, where the radius of curvature R_{y1} of the concave plane of the interface z was 30000 mm, the radius of curvature R_{z2} of the convex plane was 2500 mm, the particle density Npo of the first layer 60 was 0.003 wt %, and the particle density Npr of the second layer 62 was 0.175 wt %.

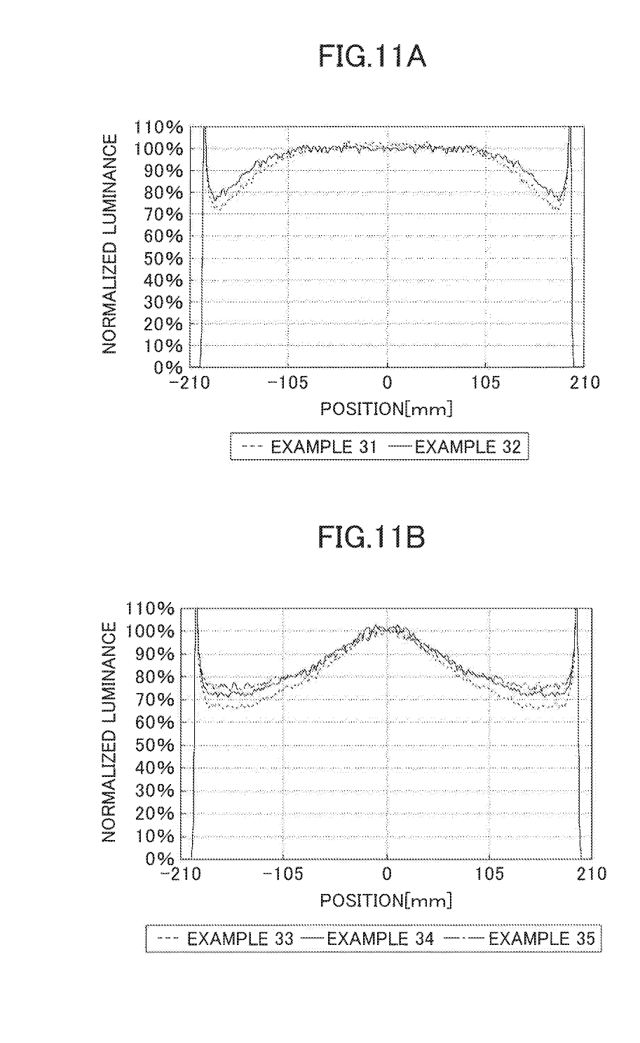

FIG. 11 illustrates normalized illuminance distributions as obtained from measurements taken of the illuminance. In FIG. 11A, the vertical axis indicates normalized illuminance, and the horizontal axis indicates distance [mm] from the center of the light guide plate. In the graph, Example 31 is indicated in a broken line, Example 32 in a solid line, and Comparative Example 31 in a thick solid line. Likewise in FIG. 11B, Example 33 is indicated in a broken line, Example 34 in a solid line, and Example 35 is indicated in a chain line.

As illustrated in FIGS. 11A and 11B, when the light guide plate has dimensions for a screen size of 32 inches, an arched illuminance distribution can be obtained with a configuration such that the radius of curvature R_{y1} of the concave plane of the interface z is in a range of 2500 mm≦R_{y1}≦110000 mm, and the radius of curvature R_{y2} of the convex curved plane is in a range of 2500 mm≦R_{y2}≦120000 mm.

### Example 4

In Example 4, measurements were taken of the light guide plate 80 illustrated in FIG. 9 for a screen size of 65 inches as the radii of curvature R_{y1} and R_{y2} of the concave and convex planes forming the interface z and the particle densities of the first layer 60 and the second layer 62 were changed.

Specifically, Example 4 used a light guide plate such that the length from the first light entrance plane 30c to the second light entrance plane was 830 mm, the thickness of the first light entrance plane 30c and the second light entrance plane 30d, i.e., the thickness D2 of the thickest portion was 1 mm, the amount of recess d was 0.2 mm, the radius of curvature of the light exit plane 30a was 165000 mm, the thickness D3 of the second layer 62 at the first light entrance plane was 0.18 mm, the thickness D4 of the thinnest portion of the second layer 62 was 0.16 mm, and the thickness D5 of the thickest portion of the second layer 62 was 0.35 mm. The scattering particles kneaded and dispersed into the light guide plate had a diameter of 4.5 μm.

The above light guide plate was used to measure the illuminance distribution in Example 41, where the radius of curvature R_{y1} of the concave plane of the interface z was 5000 mm, the radius of curvature R_{z2} of the convex plane was 490000 mm, the particle density Npo of the first layer 60 was 0.003 wt %, and the particle density Npr of the second layer 62 was 0.02 wt %; Example 42, where R_{y1} was 5000 mm, R_{z2} was 490000 mm, Npo was 0.003 wt %, and Npr was 0.03 wt %; Example 43, where R_{y1} was 5000 mm, R_{z2} was 490000 mm, Npo was 0.003 wt %, and Npr was 0.04 wt %; Example 44, where R_{y1} was 450000 mm, R_{z2} was 5000 mm, Npo was 0.003 wt %, and Npr was 0.02 wt %; Example 45, where R_{y1} was 450000 mm, R_{z2} was 5000 mm, Npo was 0.003 wt %, and Npr was 0.04 wt %; and Example 46, where R_{y1} was 450000 mm, R_{z2} was 5000 mm, Npo was 0.003 wt %, and Npr was 0.09 wt %.

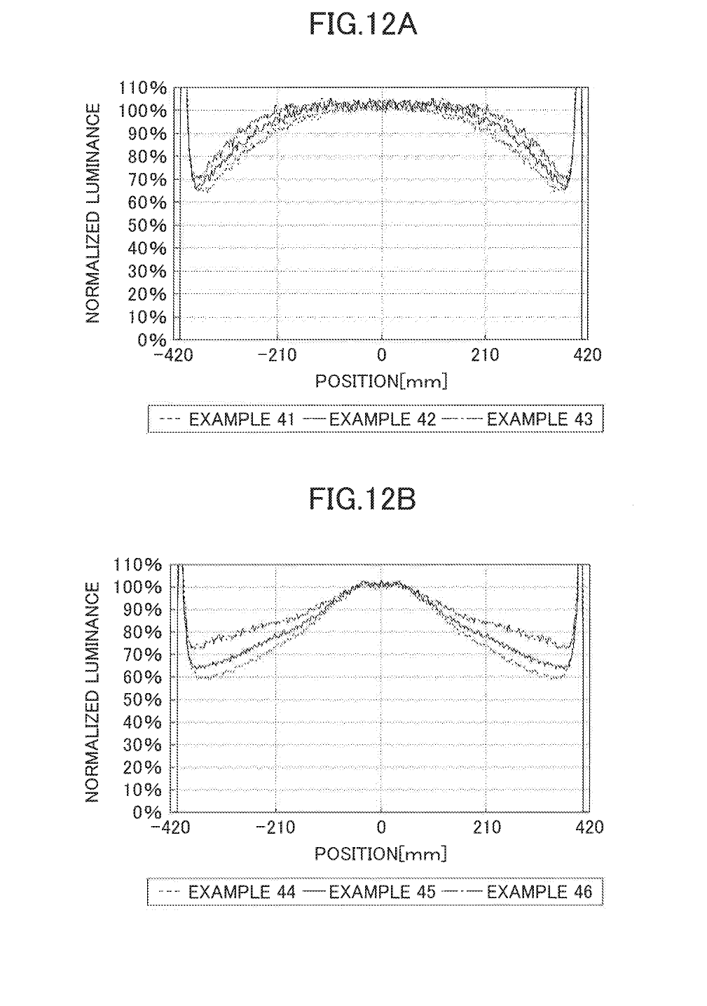

FIG. 12 illustrates normalized illuminance distributions as obtained from measurements taken of the illuminance. In FIG. 12A, the vertical axis indicates normalized illuminance, and the horizontal axis indicates distance [mm] from the center of the light guide plate. In the graph, Example 41 is indicated in a broken line, Example 42 in a solid line, Example 43 in a chain line, and Comparative Example 41 in a thick solid line. Likewise, in FIG. 12B, Example 44 is indicated in a broken line, Example 45 in a solid line, and Example 46 in a chain line.

As illustrated in FIGS. 12A and 12B, when the light guide plate has dimensions for a screen size of 65 inches, an arched illuminance distribution can be obtained with a configuration such that the radius of curvature R_{y1} of the concave plane of the interface z is in a range of 5000 mm≦R_{y1}≦450000 mm, and the radius of curvature R_{y2} of the convex curved plane is in a range of 5000 mm≦R_{y2}≦490000 mm.

### Example 5

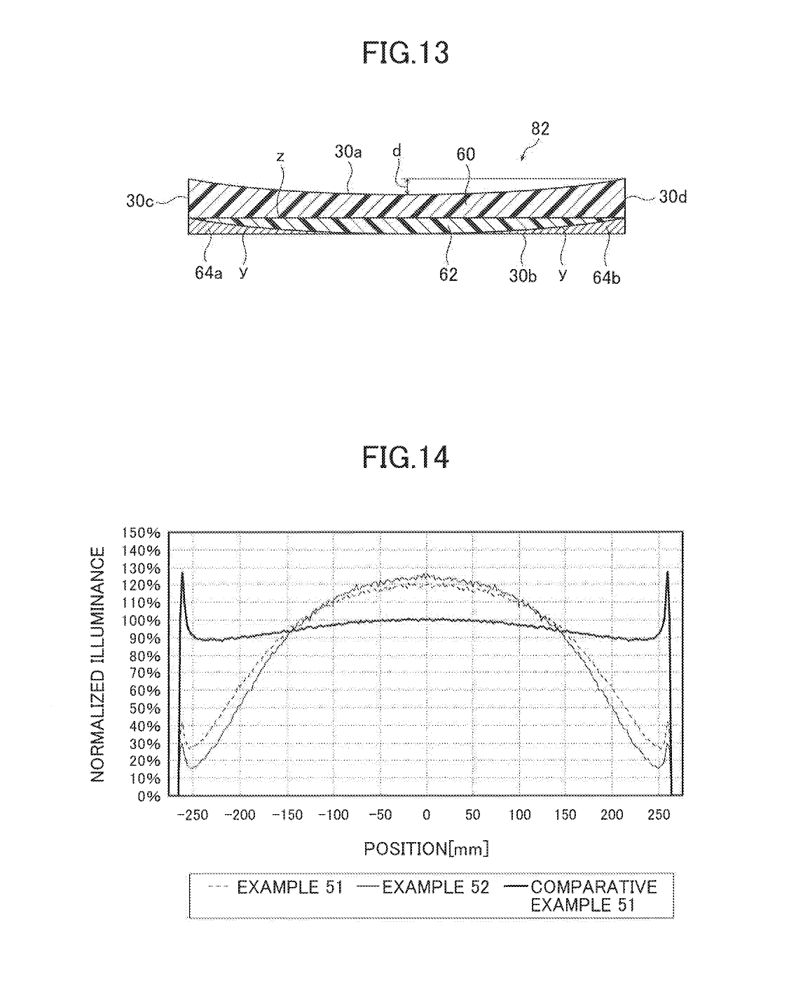

Example 5 used a light guide plate 82 having the same external shape as the light guide plate in Example 1 but composed of three layers having different particle densities. The light guide plate 82 comprises the first layer 60, the second layer 62, and third layers 64a, 64b as illustrated in FIG. 13.

The light guide plate 82 has the interface z, a flat plane, between the first layer 60 and the second layer 62 and an interface y between the second layer 62 and the third layers 64a,64b having the same concave configuration as the light exit plane 30a. Thus, the third layers 64a, 64b grows increasingly thinner from the first light entrance plane 30c and the second light entrance plane 30d toward the center and becoming thinnest in a position corresponding to the central bisector a and thickest at the two light entrance planes (the first light entrance plane 30c and the second light entrance plane 30d) on both ends.

The light guide plate 82 has a following configuration: the thickness at the bisector α is 2.56 mm; the length of the first layer 60 from the light exit plane 30a to the interface z at the bisector α, i.e., the thickness D1 of the first layer 60, is 2.12 mm; the length of the second layer 62 from the interface z to the rear plane 30b at the bisector α, i.e., the thickness D2 of the second layer 62 is 0.44 mm; the thickness D2′ of the second layer 62 at the first light entrance plane 30c and the second light entrance plane 30d is 0 mm; the thickness D3 of the third layers 64a,64b at the first light entrance plane 30c and the second light entrance plane 30d is 0.44 mm; the radius of curvature R of the light exit plane 30a and the interface y is 75000 mm; and the amount of recess d is 0.44 mm. The scattering particles kneaded and dispersed into the light guide plate had a diameter of 7 μm.

Using the light guide plate having the above configuration, measurements were taken of the illuminance distributions in Example 51 using a light guide plate having three layers, where the first layer 60 had a particle density Npo of 0 wt %, the second layer 62 a particle density Npr of 0.10 wt %, and the third layers 64a,64b a particle density of 0 wt % and in Example 52 using a light guide plate used in Example 1 and having two layers, where the first layer 60 had a particle density Npo of 0 wt % and the second layer 62 a particle density Npr of 0.10 wt %. The third layers 64a,64b may have any particle density as desired. As Comparative Example 51, measurements were also taken of a light guide plate where all the layers had a particle density of 0.05 wt %, i.e., a single-layer light guide plate such that the whole light guide plate had a consistent particle density as illustrated in FIG. 28.

FIG. 14 illustrates normalized illuminance distributions as obtained from measurements taken of the illuminance. In FIG. 14, the vertical axis indicates normalized illuminance, and the horizontal axis indicates distance [mm] from the center of the light guide plate. In the graph, Example 51 is indicated in a broken line, Example 52 in a solid line, and Comparative Example 51 in a thick solid line.

As illustrated in FIG. 14, the light guide plate in Example 51 can also have illuminance improved or decrease in illuminance alleviated near the light entrance planes (30c, 30d (light admitting portions)) and unevenness at the light admitting portions reduced as compared with the light guide plate in Example 52.

### Example 6

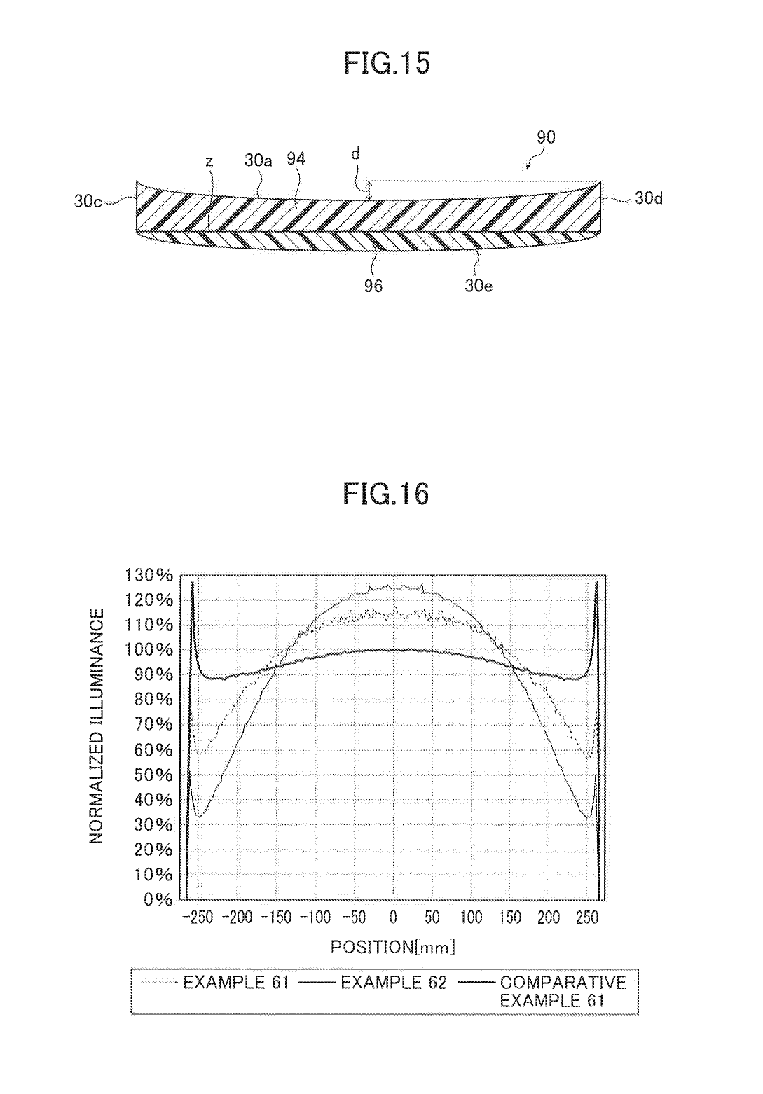

Example 6 used a light guide plate 90 of which the rear plane side had the same configuration as the light exit plane side as illustrated in FIG. 15 and which had dimensions for a screen size of 42 inches. The light guide plate where the light exit plane side and the rear plane side have the same configuration (caved with respect to the light exit plane) enables machining thereof by stacking. The interface z between the first layer and the second layer of the light guide plate 90 is a flat plane.

The light guide plate 90 illustrated in FIG. 15 as used had a following configuration: the length from the first light entrance plane 30c to the second light entrance plane 30d was 545 mm; the length from the light exit plane 30a to the rear plane 30b at the bisector α (thickness at the center) was 2.5 mm; the thickness of the first light entrance plane 30c and the second light entrance plane 30d was 2 mm; the length of the first layer 60 from the light exit plane 30a to the interface z at the bisector α, i.e., the thickness D1 of the thinnest portion of the first layer 60, was 1.56 mm; the length of the second layer 62 from the interface z to a rear plane 30e at the bisector α, i.e., the thickness D2 of the thickest portion of the second layer 62, was 0.5 mm; the radius of curvature R of the light exit plane 30a and the rear plane 30e was 75000 mm, and the amount of recess d was 0.44 mm. The scattering particles kneaded and dispersed into the light guide plate had a diameter of 4.5 μm.

Using the light guide plate having the above configuration, measurements were taken of the illuminance distribution in Example 61 where a first layer 94 had a particle density Npo of 0.02 wt % and a second layer 96 had a particle density Npr of 0.10 wt % and in Example 62 where the first layer 94 had a particle density Npo of 0 wt % and the second layer 96 had a particle density Npr of 0.10 wt %. Measurements were also taken of a single-layer light guide plate having the configuration as illustrated in FIG. 28 in Comparative Example 61 where both the first layer and the second layer had a particle density of 0.05 wt %, that is, the whole light guide plate had a consistent particle density. In the light guide plate 102 in Comparative Example 61, the length from the light exit plane 104 to the rear plane 106 at the bisector α (thickness at the center) was 3.5 mm and the thickness at the light entrance planes at the ends was 2 mm.

FIG. 16 illustrates normalized illuminance distributions as obtained from measurements taken of the illuminance. In FIG. 16, the vertical axis indicates normalized illuminance, and the horizontal axis indicates distance [mm] from the center of the light guide plate. In the graph, Example 61 is indicated in a broken line, Example 62 in a thin solid line, and Comparative Example 61 in a thick solid line.

Further, measurements were taken of the illuminance distribution using a light guide plate, where the length of the light guide plate 90 from the light exit plane 30a to the rear plane 30b at the bisector α (thickness at the center) was 3.5 mm and the thickness at the first light entrance plane 30c and the second light entrance plane 30d was 3 mm, in Example 63 where the first layer 94 had a particle density Npo of 0.02 wt % and the second layer 96 had a particle density Npr of 0.15 wt % and in Example 64 where the first layer 94 had a particle density Npo of 0 wt % and the second layer 96 had a particle density Npr of 0.15 wt %. Measurement was likewise performed in Comparative Example 61 using the single-layer light guide plate illustrated in FIG. 28.

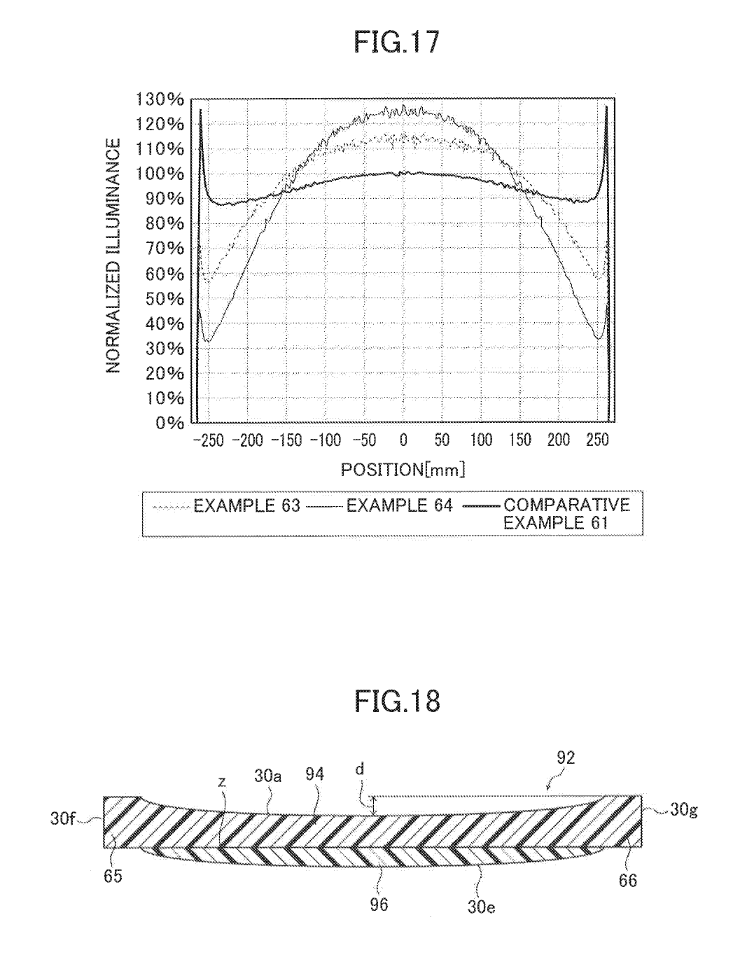

FIG. 17 illustrates normalized illuminance distributions as obtained from measurements taken of the illuminance. In FIG. 17, the vertical axis indicates normalized illuminance, and the horizontal axis indicates distance [mm] from the center of the light guide plate. In the graph, Example 63 is indicated in a broken line, Example 64 in a thin solid line, and Comparative Example 61 in a thick solid line.

As illustrated in FIGS. 16 and 17, the light guide plates in Examples 61 to 64 exhibit arched illuminance distributions similarly to the light guide plates in Examples 1 to 3 and exhibit illuminance that is improved at the center by 10% to 20% over Comparative Example 61.

Use may alternatively be made of a light guide plate 92 having a configuration where the first light entrance plane 30c and the second light entrance plane 30d of the light guide plate 90 are provided with overhangs 65, 66 as illustrated in FIG. 18 to facilitate stacking at the time of manufacture. In this case, the light entrance planes are a first light entrance plane 30f and a second light entrance plane 30g. The overhangs may have a different particle density as mixing zone, the particle density preferably being higher than the maximum density in other portions.

The radius of curvature R of the light exit plane side and the rear plane side may differ, provided that machining by stacking is possible. When the portion on the light exit plane side and the portion on the rear plane side have different radii of curvature R, the surfaces of the overhangs 65, 66 on the rear plane side may be extended toward the rear plane side farther than the portion of the rear plane 30e intersected by the bisector α or the outermost portion of the convex shape of the rear plane 30e, or spacers may be inserted, so that when the light guide plates are stacked, the overhangs come into contact with each other or the light guide plates come into contact with each other through the intermediary of the spacers, enabling manufacture with the light guide plates stably stacked. Alternatively, similar effects to those obtained with a reverse-wedge shaped light guide plate may be obtained by making the radius of curvature of the rear plane smaller than that of the light exit plane, so that the rear plane bulges out more toward the rear plane side.

Alternatively, a flat, multiple-layer light guide plate may be transformed into a concave configuration as a variation of Example 6 in lieu of a light guide plate having the same configuration as the light guide plate as illustrated in FIG. 15 caved on the light exit plane side and having the rear plane side identical in configuration to the light exit plane side. For example, similar effects as those obtained with the light guide plate illustrated in FIG. 15 may be obtained by causing a thin light guide plate to warp in the opposite direction from the liquid crystal panel so that the light guide plate is caved on the light exit plane side through a mechanical transforming means as by holding the light guide plate with a resin-made projection.

The above configuration of the light guide plate where the light exit plane has a concave configuration and the rear plane has a convex configuration and where the light guide plate comprises two layers having different particle densities (Examples 61 to 64) enables stacking at the time of manufacture and thus allows the end faces of a plurality of light guide plates to be cut and polished simultaneously. Thus, the costs for end face machining may be greatly reduced. Further, the light guide plate, caved on the light exit plane side, is less liable to warp toward the liquid crystal panel. Still further, a flat, multiple-layer light guide plate transformed into a concave configuration allows increased productivity and further reduced costs to be achieved.

It follows from the above that the light guide plate, caved on the light exit plane side, is less liable to warp toward the liquid crystal panel. The above light guide plate having a concave light exit plane and composed of two layers having different particle densities allows a larger light entrance planes to be secured than the light guide plates having a shape illustrated in FIG. 28 or 29 (reversed wedge shape), hence enhance the light incidence efficiency, so that an arched illuminance distribution can be obtained.

Further, since larger light entrance planes can be secured than with flat light guide plates having a consistent average thickness, the light incidence efficiency can be increased, and hence the weight of the light guide plate can be reduced. In addition, an arched illuminance distribution can be obtained.

It is apparent that optimizing the second layer among the two layers having different particle densities using the reverse bias density improves the illuminance near the light entrance planes and enables a yet more desirable arched illuminance distribution to be obtained.

It is also apparent that providing a third layer also improves the illuminance near the light entrance planes or alleviates decrease in illuminance and minimize uneven illuminance near the light admitting portions.

Further, forming the light exit plane side and the rear plane side into the same configuration (concave on the light exit plane side, i.e., concave on the light exit plane side and convex on the rear plane side) permits stacking at the time of manufacture and hence makes it possible to cut and polish end faces of a plurality of light guide plates at a time, achieving significant reduction of cost required for end face machining.

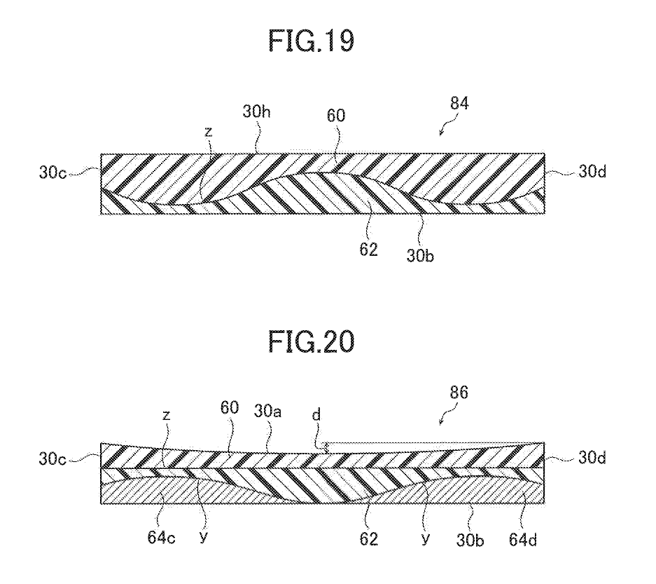

As a variation of the above Example 2, the light guide plate 80 in Example 2 may be adapted to have a zero amount of recess d, i.e., a light guide plate 84 having a flat light exit plane 30h as illustrated in FIG. 19.

As a variation of the above Example 5, Example 2 and Example 5 may be combined to obtain a three-layer light guide plate as illustrated in FIG. 20, where the interface y in the light guide plate 82 in Example 5 continuously changes so that the second layer 62 grows thinner from the light exit plane 30a at the bisector α (i.e., center of the light exit plane) toward the first light entrance plane 30c and the second light entrance plane 30d, thereafter growing thicker toward the rear plane 30b near the first light entrance plane 30c and the second light entrance plane 30d (that is, the second layer 62 (intermediate layer) dents and bulges toward the rear plane 30b), thus providing a light guide plate 86 having a combined particle density optimized using a reverse bias density.

Preferably, the relation in particle density among the three layers satisfies a “first layer 60 third layers 64a, 64b<second layer 62,” and the first layer 60 has a particle density of 0 wt %. The interface z between the first layer 60 and the second layer 62 preferably has either a flat plane or a concave configuration caved in the same direction as the light exit plane.

The above three-layer configuration facilitates fine adjustment of the luminance distribution (illuminance distribution).

Although the light guide plate according to the above embodiments is of a type comprising two light sources disposed adjacent two light entrance planes to admit light through both sides of the light guide plate, the invention is not limited to such a configuration; the light guide plate may be of a type comprising a single light source disposed adjacent one light entrance plane to admit light through one side of the light guide plate. Reduction in number of light sources permits reduction in number of component parts and hence in manufacturing costs.

When light is admitted from only one side, the light guide plate may have an asymmetrical interface z. For example, the light guide plate may have a single light entrance plane and an asymmetrical second layer such that the second layer of the light guide plate is thickest in a position on the side of the bisector of the light exit plane farther from the light exit plane.

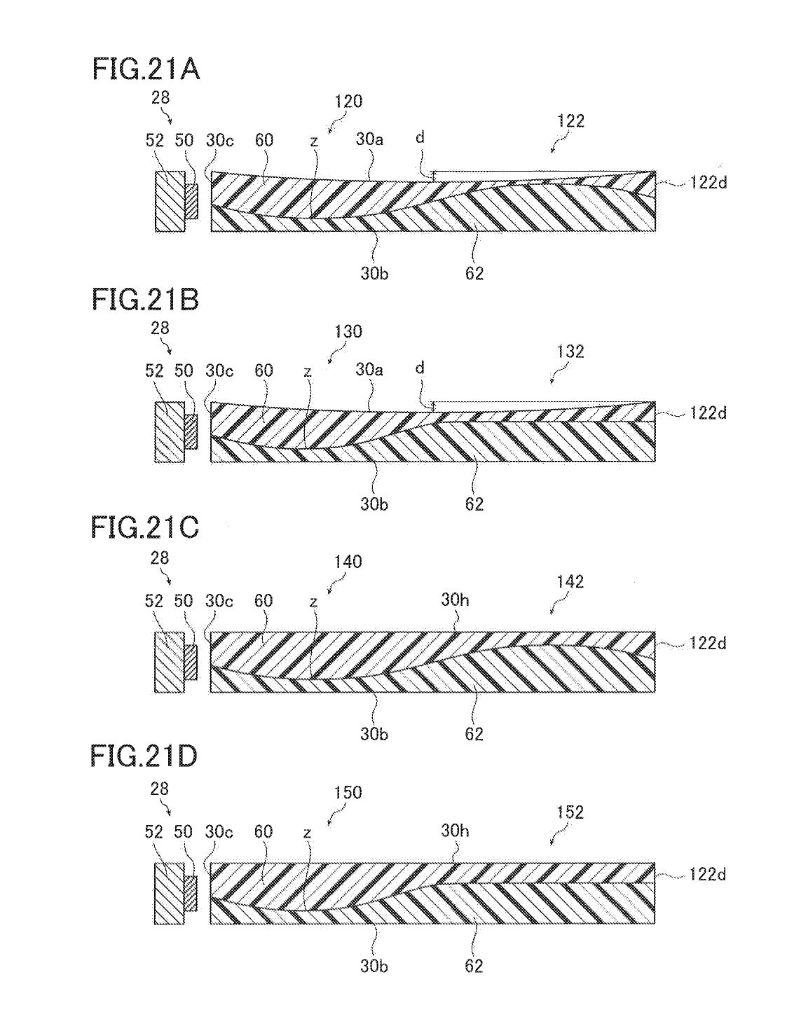

FIGS. 21A and 21B are schematic sectional views illustrating part of backlight units using other examples of light guide plates of the invention. A backlight unit 120 illustrated in FIG. 21A has a light guide plate 122 instead of the light guide plate 30 and a single light source 28 but otherwise has the same structure as the backlight unit 20; a backlight unit 130 illustrated in FIG. 21B has a light guide plate 132 instead of the light guide plate 30 and a single light source 28 but otherwise has the same structure as the backlight unit 20. Thus like components are given like alphanumeric characters, and different components are mostly described in the description to follow.

The backlight unit 120 illustrated in FIG. 21A comprises the light guide plate 122 and the light source 28 provided opposite the first light entrance plane 30c of the light guide plate 122.

The light guide plate 122 comprises the first light entrance plane 30c opposite the light source 28 and a lateral plane 122d opposite from the first light entrance plane 30c.

The light guide plate 122 comprises the first layer 60 on the side closer to the light exit plane 30a and the second layer on the side closer to the rear plane 30b. The interface z between the first layer 60 and the second layer 62 continuously changes so that the second layer 62, when seen in a cross section perpendicular to the longitudinal direction of the first light entrance plane 30c, changes so as to grow thinner once from the first light entrance plane 30c toward the lateral plane 122d, thereafter growing thicker before growing thinner again. Thus, the interface z is a curved plane caved with respect to the light exit plane 30a on the side closer to the first light entrance plane 30c and a curved plane convexed with respect to the light exit plane 30a on the side closer to the lateral plane 122d.

Thus, the density profile of the combined particle density has a curve having a minimum value on the side closer to the light entrance plane 30c and having a maximum value on the side closer to the lateral plane 122d.

The backlight unit 130 illustrated in FIG. 21B comprises the light guide plate 132 and the light source 28 provided opposite the first light entrance plane 30c of the light guide plate 132.

The light guide plate 132 comprises the first light entrance plane 30c opposite the light source 28 and a lateral plane 122d opposite from the first light entrance plane 30c.

The light guide plate 132 comprises the first layer 60 on the side closer to the light exit plane 30a and the second layer on the side closer to the rear plane 30b. The interface z between the first layer 60 and the second layer 62 continuously changes so that the second layer 62, when seen in a cross section perpendicular to the longitudinal direction of the first light entrance plane 30c, once grows thinner from the first light entrance plane 30c toward the lateral plane 122d, thereafter growing thicker before leveling off in thickness. Thus, the interface z exhibits a curved plane caved with respect to the light exit plane 30a on the side closer to the first light entrance plane 30c, a curved plane convex toward the light exit plane 30a in the central portion of the light guide plate, and a flat plane parallel to the light exit plane 30a on the side closer to the lateral plane 122d.

Thus, in a case using a single light source to admit light from one side, forming the interface z into an asymmetrical configuration such that the thickness of the second layer reaches a minimum in a position near the light entrance plane and reaches a maximum in a position distant from the light entrance plane enables the light emitted from the light source and admitted through the light entrance plane to be guided deep into the light guide plate and allows the light emitted from the light exit plane to exhibit an arched curve, improving light use efficiency.

Further, since larger light entrance plane can be secured than with flat light guide plates having a consistent average thickness, the light incidence efficiency can be increased, and hence the weight of the light guide plate can be reduced.

Although the light guide plates 122 and 132 illustrated in FIGS. 21A and 21B have a concave light exit plane, the present invention is not limited thereto; the light exit plane may be a flat plane as in light guide plates 142 and 152 illustrated in FIGS. 21C and 21D.

A light guide plate used in the backlight units of a type admitting light from one side as illustrated in FIG. 21 may also have such densities in the first layer and the second layer and such configuration of the interface z as ensure that the combined particle density is a density obtained using the reverse bias density. For a light guide plate admitting light from one side, the reverse bias density may be obtained from an illuminance distribution obtained by introducing light into a light guide plate having the same configuration but containing no particles from one side thereof.

The concave and convex planes forming the interface z may be a curve that is a part of a circle or an ellipse in a cross section perpendicular to the longitudinal direction of the light entrance plane or may be a curve of second order or a curve expressed by a polynomial or a curve formed by a combination thereof.

When the concave and convex planes in a light guide plate where, as illustrated in FIG. 21A, the interface z has a concave and convex configuration are each formed of a part of a circle in a cross section perpendicular to the longitudinal direction of the light entrance plane, a radius of curvature R_{z1} of the concave configuration is preferably in a range of 2500 mm≦R_{z1}≦450000 mm and a radius of curvature R_{z2} of the convex configuration is preferably in a range of 2500 mm≦R_{z2}≦490000 mm.

R_{z1} and R_{z2} within the above ranges yield an arched illuminance distribution in a more desirable manner.

When the concave and convex planes in a light guide plate where, as illustrated in FIG. 21B, the interface z has a concave and convex configuration and a flat plane combined are each formed of a part of a circle in a cross section perpendicular to the longitudinal direction of the light entrance plane, a radius of curvature Rₓ₁ of the concave configuration is preferably in a range of 2500 mm≦Rₓ₁≦450000 mm, and a radius of curvature Rₓ₂ of the convex configuration is preferably in a range of 2500 mm≦Rₓ₂≦490000 mm.

Rₓ₁ and Rₓ₂ within the above ranges yield an arched illuminance distribution in a more desirable manner.

Now, the backlight units 120 and 130 will be described in greater detail with reference to specific examples.

### Example 7

Example 7 used the light guide plate 120 corresponding to a 46-inch screen. Specifically, the light guide plates used had a following configuration: the length from the first light entrance plane 30c to the lateral plane 122d was 592 mm; the length from the light exit plane 30a to the rear plane 30b at the bisector α, i.e., the thickness D1 of the thinnest portion, was 0.8 mm; the thickness at the first light entrance plane 30c and the lateral plane 122d, i.e., the thickness D2 of the thickest portion, was 1.0 mm; the thickness D3 of the second layer 62 at the first light entrance plane was 0.21 mm; the thickness D4 of the thinnest portion of the second layer 62 was 0.17 mm; the thickness D5 of the thickest portion of the second layer 62 was 0.5 mm; the radius of curvature R of the light exit plane 30a was 87500 mm; the amount of recess d was 0.2 mm; the radius of curvature R_{z1} of the concave plane of the interface z was 35000 mm; and the radius of curvature R_{z2} of the convex plane was 55000 mm. The scattering particles kneaded and dispersed into the light guide plate had a diameter of 4.5 μm. The scattering particles were not dispersed into the first layer 60 (Npo=0); the second layer 62 had the particle density Npr of 0.065 wt %.

In Comparative Example 71, measurements were taken of the luminance distribution of a one-layer light guide plate having the configuration as illustrated in FIG. 28, with light admitted from two sides. Measurement was made with the light guide plate where the thickness thereof at the center was 3.5 mm, the thickness of the light entrance plane was 2 mm, and the particle density was 0.05 wt %.

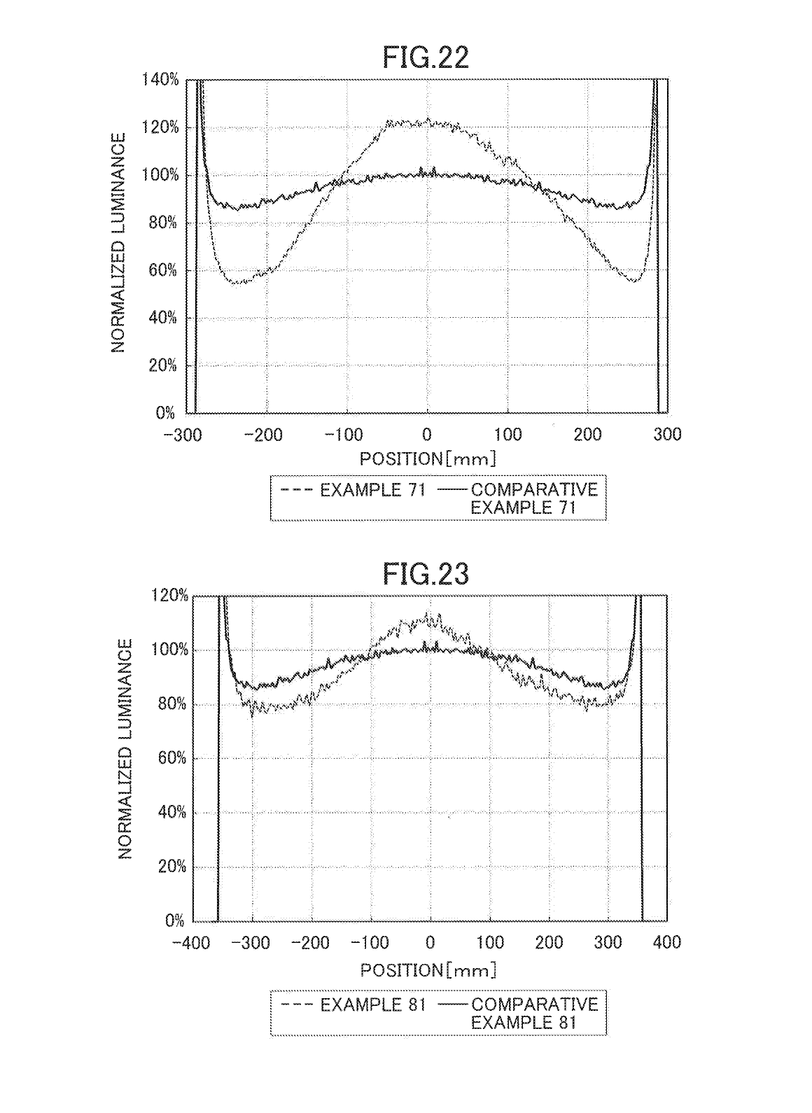

FIG. 22 illustrates normalized luminance distributions, measurements of illuminance. In FIG. 22, the vertical axis indicates normalized luminance, and the horizontal axis indicates distance [mm] from the center of the light guide plate. In the graph, Example 71 is indicated in a thin broken line, and Comparative Example 71 in a thick solid line.

As illustrated in FIG. 22, even in the case of light being admitted from one side, the light guide plate in Example 71 where the interface z has a concave and convex configuration exhibits an improved luminance at the center over Comparative Example 71 and can yield an arched illuminance distribution.

### Example 8

Example 8 used the light guide plate 130 corresponding to a 57-inch screen. Specifically, the light guide plate used had a following configuration: the length from the first light entrance plane 30c to the lateral plane 122d measured 730 mm; the length from the light exit plane 30a to the rear plane 30b at the bisector α, i.e., the thickness D1 of the thinnest portion, was 0.8 mm; the thickness at the first light entrance plane 30c and the lateral plane 122d, i.e., the thickness D2 of the thickest portion, was 1.0 mm; the thickness D3 of the second layer 62 at the first light entrance plane was 0.19 mm; the thickness D4 of the thinnest portion of the second layer 62 was 0.15 mm; the thickness D5 of the thickest portion of the second layer 62 was 0.31 mm; the radius of curvature R of the light exit plane 30a was 135000 mm; the amount of recess d was 0.2 mm; and the radius of curvature Rx1 of the concave plane of the interface z was 100000 mm. The scattering particles kneaded and dispersed into the light guide plate had a diameter of 4.5 μm. The scattering particles were not dispersed into the first layer 60 (Npo=0); the second layer 62 had the particle density Npr of 0.06 wt %.

In Comparative Example 81, measurements were taken of the luminance distribution of a one-layer light guide plate having the configuration as illustrated in FIG. 28, with light admitted from two sides. Measurement was made with the light guide plate where the thickness thereof at the center was 3.5 mm, the thickness of the light entrance plane was 2 mm, and the particle density was 0.05 wt %.

FIG. 23 illustrates normalized illuminance distributions as obtained from measurements taken of the illuminance. In FIG. 23, the vertical axis indicates normalized illuminance, and the horizontal axis indicates distance [mm] from the center of the light guide plate. In the graph, Example 81 is indicated in a thin broken line and Comparative Example 81 in a thick solid line.

As illustrated in FIG. 23, even in the case of light being admitted from one side, the light guide plate in Example 81 where the interface z has a concave and convex configuration combined with a flat plane exhibits an improved luminance at the center over the light guide plate in Comparative Example 81 and can yield an arched illuminance distribution.

Although the light guide plates admitting light from one side illustrated in FIGS. 21A to 21D have a flat rear plane parallel to the light travel direction (light exit plane), the present invention is not limited thereto; the rear plane may be inclined with respect to the light travel direction.

In the light guide plates illustrated in FIGS. 21B and 21D, the interface z between the first layer 60 and the second layer 62 is a concave plane with respect to the light exit plane on the side closer to the first light entrance plane 30c, a convex plane with respect to the light exit plane in the central portion of the light guide plate, and a flat plane parallel to the light exit plane on the side closer to the lateral plane 122d from the vertex of the convex plane, but the present invention is not limited thereto; the interface z may be composed of a plurality of planes including a concave plane, a convex plane, a plane parallel to the light exit plane, and a plane inclined with respect to the light exit plane.

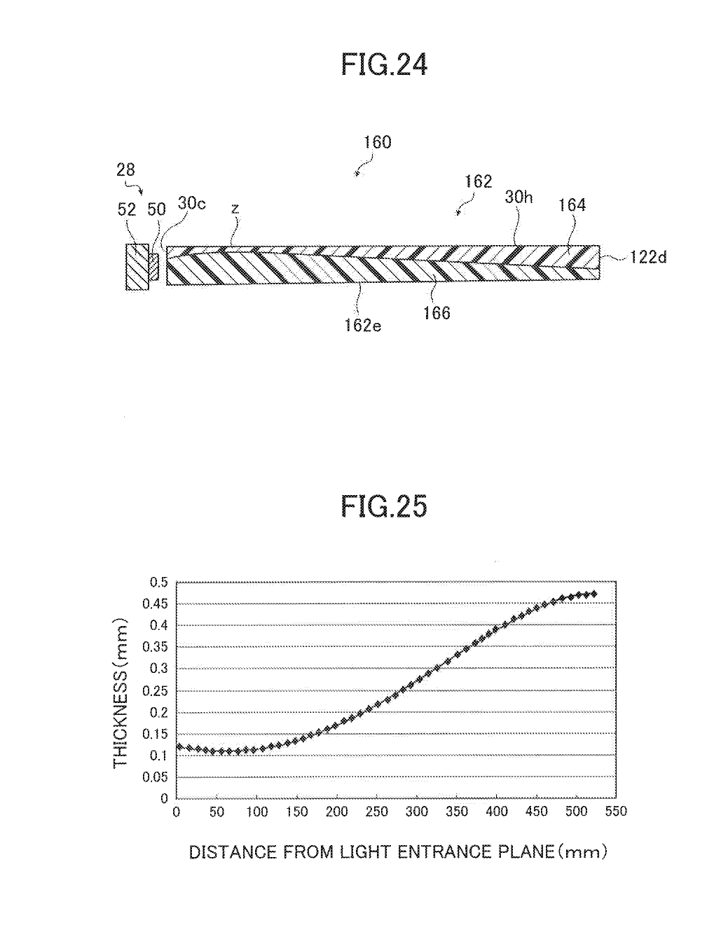

FIG. 24 is a schematic sectional view illustrating part of a backlight unit using another example of the light guide plate of the invention. The backlight unit illustrated in FIG. 24 has the same configuration as the backlight unit 150 except that a light guide plate 162 is provided in lieu of the light guide plate 152. In the following, like components will be given like characters, and the description will be focused on the components different between these backlight units.

A backlight unit 160 illustrated in FIG. 24 comprises the light guide plate 162 and the light source 28 provided opposite the first light entrance plane 30c of the light guide plate 162.

The light guide plate 162 has a rear plane 162b inclined with respect to the light exit plane 30h so that the thickness perpendicular to the light exit plane 30h decreases with the increasing distance from the light entrance plane 30c.

The light guide plate 162 comprises a first layer 164 on the side closer to the light exit plane 30h and a second layer 166 on the side closer to the rear plane 162b. The first layer 164 has a higher particle density of scattering particles than the second layer 166.

The interface z between the first layer 164 and the second layer 166 continuously changes so that the first layer 164, when seen in a cross section perpendicular to the longitudinal direction of the first light entrance plane 30c, once grows thinner from the first light entrance plane 30c toward the lateral plane 122d, before growing thicker. Thus, the interface z is a curved plane convexed with respect to the light exit plane 30h on the side closer to the first light entrance plane 30c and a curved plane caved in with respect to the light exit plane 30h on the side closer to the lateral plane 122d. The convex plane and the concave plane are smoothly connected by a flat plane inclined with respect to the light exit plane 30h in a direction such that the first layer 164 grows thicker with the increasing distance from the first light entrance plane 30c.

Thus, the interface z, having an asymmetric shape formed of combined curved and flat planes such that the thickness of a layer having a higher particle density of scattering particles reaches a minimum in a position near the light entrance plane and reaches a maximum in a position distant from the light entrance plane, enables the light emitted from the light source and admitted through the light entrance plane to be guided deep into the light guide plate and improves light use efficiency.

Now, the backlight unit 160 will be described in greater detail with reference to specific examples.

### Example 9

Example 9 used the light guide plate 162 having a configuration illustrated in FIG. 24 and corresponding to a 40-inch screen. Specifically, the light guide plate used had a configuration such that the length from the first light entrance plane 30c to the lateral plane 122d was 500 mm; the interface z between the first layer 164 and the second layer 166 was formed of a curved plane convexed with respect to the light exit plane 30h on the side closer to the first light entrance plane 30c, a curved plane concaved with respect to the light exit plane 30h on the side closer to the lateral plane 122d, and a flat plane smoothly connecting the convex and the concave plane; the scattering particles kneaded and dispersed into the light guide plate had a particle diameter of 4.5 μm; and the second layer 166 had a particle density of scattering particles of 0 wt %. The light emission face of each of the LED chips 50 used in the light source 28 had a vertical length a of 1.5 mm and a horizontal length b of 2.6 mm. The LED chips 50 were spaced from the light entrance plane 30c of the light guide plate 162 by a gap of 0.2 mm.

FIG. 25 illustrates a relation between the distance from the light entrance plane 30c and the thickness of the first layer 164. The thickness of the first layer 164 more specifically exhibits a configuration as illustrated in FIG. 25.

Using the light guide plate having the above configuration, measurements were taken of the illuminance distribution in following examples: Example 91 where the length of the light entrance plane 30c from the light exit plane 30h to the rear plane 162e (thickness of the light entrance plane 30c) was 2 mm, the length of the lateral plane 122d from the light exit plane 30h to the rear plane 162e (thickness of the lateral plane 122d) was 0.5 mm, and the particle density of the scattering particles of the first layer 164 was 0.12 wt %; Example 92 where the thickness of the light entrance plane 30c was 2 mm, the thickness of the lateral plane 122d was 1.0 mm, and the particle density of the scattering particles of the first layer 164 was 0.163 wt %; Example 93 where the thickness of the light entrance plane 30c was 2 mm, the thickness of the lateral plane 122d was 1.25 mm, and the particle density of the scattering particles of the first layer 164 was 0.188 wt %; Example 94 where the thickness of the light entrance plane 30c was 2 mm, the thickness of the lateral plane 122d was 1.5 mm, and the particle density of the scattering particles of the first layer 164 was 0.203 wt %; and Example 95 where the thickness of the light entrance plane 30c was 2 mm, the thickness of the lateral plane 122d was 1.75 mm, and the particle density of the scattering particles of the first layer 164 was 0.21 wt %.

The illuminance distribution was also measured in Example 96 where the thickness of both the light entrance plane 30c and the lateral plane 122d was 1.5 mm and Example 97 where the thickness of both the light entrance plane 30c and the lateral plane 122d was 2 mm.

The illuminance distribution was also measured in Comparative Example 91 where the light guide plate had a configuration illustrated in FIG. 28, the thickness was 2 mm at the light entrance planes and 3.5 mm at the center, and the particle density was 0.05 wt %. Light was admitted from both sides.

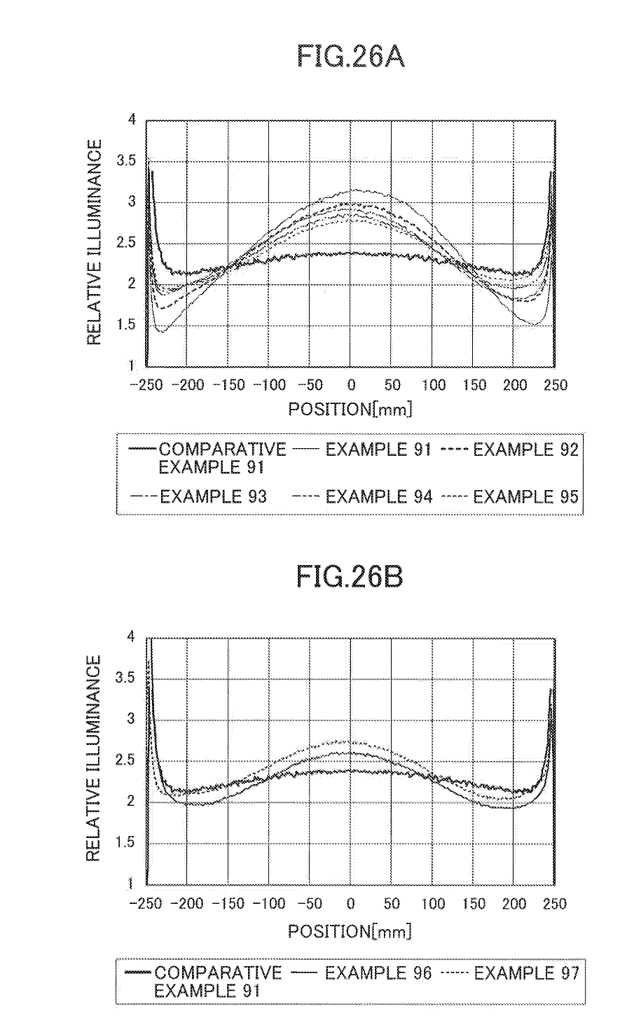

The measurements obtained are illustrated in FIGS. 26A and 26B. In FIG. 26, the vertical axis indicates relative illuminance, and the horizontal axis indicates distance [mm] from the center of the light guide plate. In FIG. 26A, Example 91 is indicated in a thin solid line, Example 92 in a thick broken line, Example 93 in a chain line, Example 94 in a chain double-dashed line, Example 95 in a thin broken line, and Comparative Example 91 in a thick solid line. In FIG. 26B, Example 96 is indicated in a thin solid line, Example 97 in a broken line, and Comparative Example 91 in a thick solid line.

As illustrated in FIGS. 26A and 26B, even in the case of light being admitted from one side, forming the interface z into a combined shape composed of a concave plane and a convex plane with respect to the light exit plane, a plane parallel to the light entrance plane, and a plane inclined with respect to the light entrance plane and providing an inclined rear plane yield more preferable distributions of particle densities of scattering particles kneaded and dispersed into the light guide plate and a more preferable combined particle density and enable an arched illuminance distribution to be obtained, resulting in an arched illuminance distribution having a central luminance improved over the light guide plate in Comparative Example 91 where light is admitted from both sides.

When the light source 28 to be used has LED chips 50 of which the length (height) a perpendicular to the light exit plane of the light guide plate is 70% or less of the thickness of the light entrance plane of the light guide plate (thickness perpendicular to the light exit plane), the light guide plate to be used therewith preferably has a flat light exit plane.

While, as described above, the amount of light of the light source 28 can be increased and the amount of light emitted from the backlight unit can be increased as the height a of the LED chips 50 (light emission face 58) increases, the efficiency with which the light emitted from the light source 28 enters the light guide plate decreases as the height a of the LED chips 50 increases with respect to the light entrance plane of the light guide plate.

Conversely, the light incidence efficiency can be improved by reducing the height a of the LED chips 50 in relation to the thickness of the light entrance plane of the light guide plate. In particular, setting the height a of the LED chips 50 to 70% or less of the thickness of the light entrance plane of the light guide plate improves the light incidence efficiency in a more preferable manner.

Where the height a of the LED chips 50 is set to 70% or less of the thickness of the light entrance plane, use is preferably made of a light guide plate having a flat light exit plane. Use of a light guide plate having a flat light exit plane enables the emitted light to exhibit an arched luminance distribution without lowering the emission efficiency as compared with a light guide plate having a concave light exit plane.

Next, a more detailed description is made below of the shape of the light exit plane of a light guide plate where the height a of the LED chips 50 is 70% or less of the thickness of the light entrance plane with reference to specific examples.

### Example 11A

Example 111 used a backlight unit comprising a light guide plate having a flat light exit plane or, more specifically, a light guide plate having the configuration of the light guide plate 84 illustrated in FIG. 19 and corresponding to a 40-inch screen. The light guide plate used had a configuration such that the distance from the first light entrance plane 30c to the second light entrance plane 30d was 500 mm, the length from the light exit plane 30h to the rear plane 30b, i.e., the thickness of the light guide plate 84, was 2.3 mm, the thickness of the second layer 62 at the bisector α was 0.61 mm, the thickness of the second layer 62 at the thinnest position thereof was 0.21 mm, the thickness of the second layer 62 at the light entrance planes (30c, 30d) was 0.28 mm, and the distance from the light entrance planes (30c, 30d) to the thinnest position of the second layer 62 was 46.5 mm. The scattering particles kneaded and dispersed into the light guide plate 84 had a diameter of 4.5 μm. The first layer 60 had the particle density Npo of 0.02 wt %; the second layer 62 had the particle density Npr of 0.26 wt %.

The height a of the light emission faces 58 of the LED chips 50 was 1.15 mm.

The above backlight unit was used to measure luminance distribution, middle-to-periphery ratio, and light use efficiency.

Example 112 used a backlight unit comprising a light guide plate having a concave light exit plane or, more specifically, a light guide plate having the configuration of the light guide plate 80 illustrated in FIG. 9 and corresponding to a 40-inch screen.

The backlight unit in Example 112 was the same as in Example 111 except that the thickness of the light guide plate 80 at the bisector α was 2.3 mm, the same thickness as in the light guide plate 84 in Example 111, and the thickness at the light entrance planes (30c, 30d) was 2.7 mm while the light exit plane 30a had a concave plane.

The above backlight unit was used to measure luminance distribution, middle-to-periphery ratio, and light use efficiency.

The luminance distribution, the middle-to-periphery ratio, and the light use efficiency of the backlight unit in Example 113 were measured as in Example 111 except that the height a of the light emission faces 58 of the LED chips 50 was 1.5 mm.

The luminance distribution, the middle-to-periphery ratio, and the light use efficiency of the backlight unit in Example 114 were measured as in Example 112 except that the height a of the light emission faces 58 of the LED chips 50 was 1.5 mm.

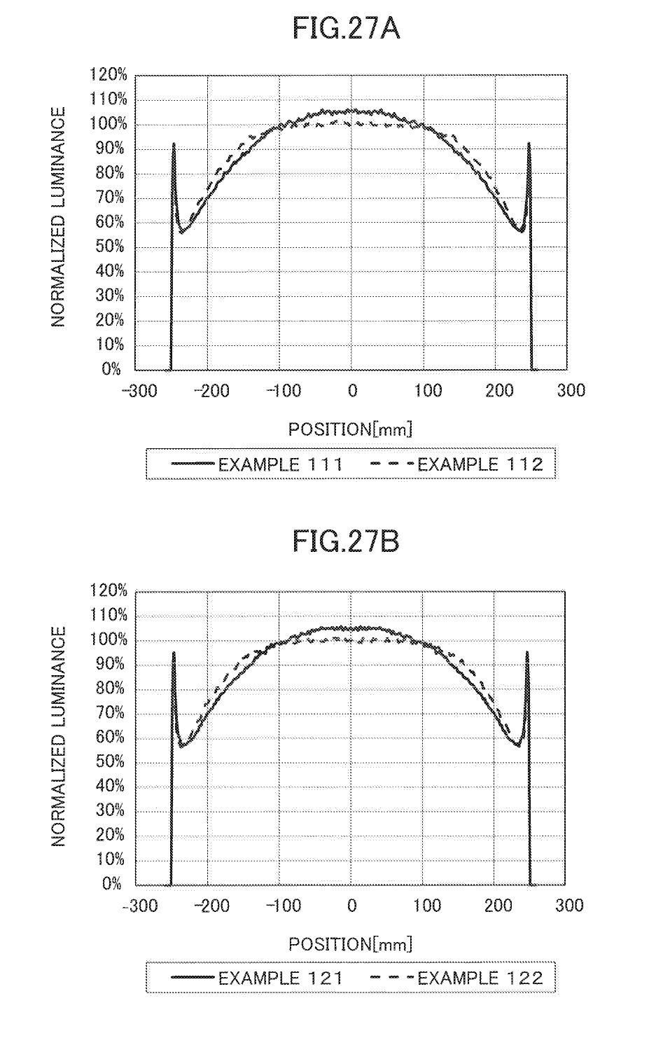

The measured luminance distributions are illustrated in FIGS. 27A and 27B. In FIG. 27A, the vertical axis shows normalized luminance with respect to the maximum luminance in Example 112; the horizontal axis shows distance (position) [mm] from the center of the light guide plate. Likewise, in FIG. 27B, the vertical axis shows normalized luminance with respect to the maximum luminance in Example 114; the horizontal axis shows distance (position) [mm] from the center of the light guide plate. FIG. 27A shows Example 111 in solid line and Example 112 in broken line. FIG. 27B shows Example 113 in solid line and Example 114 in broken line.

Table 4 shows measurements taken of light use efficiency and middle-to-periphery ratio of the measured light.

The middle-to-periphery ratio herein denotes the ratio of the maximum luminance in the position corresponding to the central portion of the light guide plate to the minimum luminance in the position near the light entrance planes in the graphs shown in FIGS. 27A and 27B. The steep rise of luminance in regions close to the light entrance planes is due to leakage of light emitted from the light sources and therefore disregarded. The middle-to-periphery ratio in Example 111 is expressed as ratio to Example 112; the middle-to-periphery ratio in Example 113 is expressed as ratio to Example 114.

TABLE 4

| | Light use efficiency | Middle-to-periphery ratio |
|---|---|---|
| Example 111 | 100.4% | 106% |
| Example 112 | 100.0% | 100% |
| Example 113 | 100.4% | 105% |
| Example 114 | 100.0% | 100% |

As shown in FIGS. 27A, 27B, and Table 4, when the height of the LED chips 50 is 70% or less of the thickness of the light entrance planes of the light guide plate, the light use efficiencies in Examples 111 and 113, where the light exit plane of the light guide plate is flat, are equivalent to those in Examples 112 and 114, where the light exit plane has a concave shape, so that the outgoing light can yield an arched luminance distribution.

The backlight unit using the light guide plate of the invention is not limited this way, however; besides the two light sources, the light guide plate may be provided additionally with opposite light sources on the lateral planes adjacent the shorter sides of the light exit plane of the light guide plate. Increasing the number of light sources enhances the intensity of light emitted from the light guide plate.

Light may be allowed to exit from not only the light exit plane but the rear plane side.

While the light guide plate, the planar lighting device, and the liquid crystal display device of the invention have been described above in detail, the invention is not limited in any manner to the above embodiments, and various improvements and modifications may be made without departing from the spirit of the present invention.

### DESCRIPTION OF SYMBOLS

10 liquid crystal display device
12 liquid crystal display panel
14 drive unit
20, 120, 130, 140, 150, 160 backlight units (planar lighting devices)
24 main body of the lighting device
24a, 30a, 30h light exit planes
26 housing
28 light source
30, 80, 82, 84, 86, 90, 92, 122, 132, 142, 152, 162 light guide plates
30b, 30b′, 30e, 162b rear planes
30c, 30d first light entrance planes
30d, 30g second light entrance planes
32 optical member unit
32a, 32c diffusion sheets
32b prism sheet
34 reflection plate
36 upper light guide reflection plate
38 lower light guide reflection plate
42 lower housing
44 upper housing
46 turnup member
48 support member
49 power unit casing
50 LED chips
52 light source mount
58 light emission face
60, 94, 164 first layers
62, 96, 166 second layers
64a, 64b third layers
122d lateral plane
α bisector
y, z interface

1-25. (canceled)

26. A light guide plate comprising a rectangular light exit plane, at least one light entrance plane provided on a side of the light exit plane for admitting light traveling substantially parallel to the light exit plane, a rear plane provided opposite from the light exit plane, and scattering particles dispersed inside,
wherein the light guide plate includes two or more layers lying on each other in a direction substantially perpendicular to the light exit plane and having different densities of the scattering particles,
wherein the two or more layers include at least a first layer provided closer to the light exit plane and having the particle density of Npo and a second layer provided closer to the rear plane than the first layer and having the particle density of Npr, a relation between Npo and Npr satisfying Npo<Npr,
wherein a cross section lying in a direction from the at least one light entrance plane toward a center of the light exit plane and perpendicular to the at least one light entrance plane has a concave configuration on a side closer to the light exit plane, and
wherein thicknesses of the first layer and the second layer in a direction substantially perpendicular to the light exit plane change, and a combined particle density in a direction perpendicular to the light entrance plane changes.

27. The light guide plate according to claim 26,
wherein an interface between the first layer and the second layer is convexed toward the light exit plane in a portion corresponding to a center of the light exit plane in the cross section lying in the direction from the at least one light entrance plane toward the center of the light exit plane and perpendicular to the at least one light entrance plane.

28. The light guide plate according to claim 27,
wherein the combined particle density is obtained using a reverse bias density and, according to the combined particle density, the thickness of the second layer continuously changes so as to grow thinner from the portion corresponding to the center portion of the light exit plane toward the at least one light entrance plane and grow thicker toward the at least one light entrance plane near the at least one light entrance plane.

29. The light guide plate according to claim 26,
wherein the light exit plane and the rear plane have a flat configuration, and the concave configuration of the light exit plane side is formed by causing the light guide plate to warp toward the rear plane side.

30. A light guide plate comprising a rectangular light exit plane, at least one light entrance plane provided on a side of the light exit plane for admitting light traveling substantially parallel to the light exit plane, a rear plane provided opposite from the light exit plane, and scattering particles dispersed inside,
wherein the light guide plate includes two or more layers lying on each other in a direction substantially perpendicular to the light exit plane and having different densities of the scattering particles,
wherein the two or more layers include at least a first layer provided closer to the light exit plane and having the particle density of Npo and a second layer provided closer to the rear plane than the first layer and having the particle density of Npr, a relation between Npo and Npr satisfying Npo<Npr, and
wherein a thickness of the second layer continuously changes so as to once decrease with an increasing distance from the light entrance plane and then increase.

31. The light guide plate according to claim 26,
wherein the thickness of the second layer is thickest in the portion corresponding to the central portion of the light exit plane.

32. The light guide plate according to claim 26,
wherein the interface between the first layer and the second layer has a flat configuration and the second layer has a convex configuration on an opposite side from the light exit plane,
and wherein the light guide plate includes a third layer having a concave configuration on a side closer to the light exit plane corresponding to the convex configuration of the second layer.

33. The light guide plate according to claim 26,
wherein the interface between the first layer and the second layer is a plane formed by a curved plane that is concave with respect to the light exit plane on a side closer to one of the light entrance planes connected with a curved plane that is convex with respect to the light exit plane on a side opposite from the light entrance plane.

34. The light guide plate according to claim 26,
wherein the interface between the first layer and the second layer is a plane formed by a curved plane that is concave with respect to the light exit plane on a side closer to one of the light entrance planes, a parallel plane that is parallel to the light exit plane on a side opposite from said light entrance plane, and a curved plane that is convex with respect to the light exit plane and connects the concave plane and the parallel plane.

35. The light guide plate according to claim 26,
wherein the interface between the first layer and the second layer is a plane formed by a curved plane that is concave with respect to the light exit plane on the one light entrance plane side, an inclined plane located on a side opposite from said light entrance plane and inclined with respect to the light exit plane, and a curved plane that is convex with respect to the light exit plane and connects the concave plane and the inclined plane.

36. The light guide plate according to claim 26,
wherein the interface between the first layer and the second layer is a plane formed by a curved plane that is concave with respect to the light exit plane on the one light entrance plane side, a curved plane that is located on a side opposite from said light entrance plane and is convex with respect to the light exit plane, and an inclined flat plane that is inclined with respect to the light exit plane and connects the concave plane and the convex plane.

37. The light guide plate according to claim 26,
wherein the cross section lying in a direction from the light entrance plane toward the central portion of the light exit plane and perpendicular to the at least one light entrance plane further has a concave configuration also on a side closer to the rear plane.

38. A planar lighting device comprising the light guide plate according to claim 30 and a light source provided opposite the at least one light entrance plane.

39. A planar lighting device according to claim 30,
wherein a length of a light emission face of the light source in a direction perpendicular to the light exit plane of the light guide plate is 70% or less of a height of the at least one light entrance plane of the light guide plate.

40. A liquid crystal display device comprising the planar lighting device described in claim 38, a liquid crystal display panel disposed on a side of the planar lighting device closer to the light exit plane of the planar lighting device, and a drive unit for driving the liquid crystal display panel.

41. The light guide plate according to claim 26,
wherein the thickness of the second layer continuously changes so as to once decrease with an increasing distance from the light entrance plane and then increase, in all cross sections perpendicular to a longitudinal direction of the at least one of light entrance plane.

42. The light guide plate according to claim 30,
wherein the thickness of the second layer continuously changes so as to once decrease with an increasing distance from the light entrance plane and then increase, in all cross sections perpendicular to a longitudinal direction of the at least one of light entrance plane.

43. The light guide plate according to claim 30,
wherein the thickness of the second layer is thickest in the portion corresponding to the central portion of the light exit plane.

44. The light guide plate according to claim 30,
wherein the interface between the first layer and the second layer has a flat configuration and the second layer has a convex configuration on an opposite side from the light exit plane,
and wherein the light guide plate includes a third layer having a concave configuration on a side closer to the light exit plane corresponding to the convex configuration of the second layer.

45. The light guide plate according to claim 30,
wherein the interface between the first layer and the second layer is a plane formed by a curved plane that is concave with respect to the light exit plane on a side closer to one of the light entrance planes connected with a curved plane that is convex with respect to the light exit plane on a side opposite from the light entrance plane.

46. The light guide plate according to claim 30,
wherein the interface between the first layer and the second layer is a plane formed by a curved plane that is concave with respect to the light exit plane on a side closer to one of the light entrance planes, a parallel plane that is parallel to the light exit plane on a side opposite from said light entrance plane, and a curved plane that is convex with respect to the light exit plane and connects the concave plane and the parallel plane.

47. The light guide plate according to claim 30,
wherein the interface between the first layer and the second layer is a plane formed by a curved plane that is concave with respect to the light exit plane on the one light entrance plane side, an inclined plane located on a side opposite from said light entrance plane and inclined with respect to the light exit plane, and a curved plane that is convex with respect to the light exit plane and connects the concave plane and the inclined plane.

48. The light guide plate according to claim 30,
wherein the interface between the first layer and the second layer is a plane formed by a curved plane that is concave with respect to the light exit plane on the one light entrance plane side, a curved plane that is located on a side opposite from said light entrance plane and is convex with respect to the light exit plane, and an inclined flat plane that is inclined with respect to the light exit plane and connects the concave plane and the convex plane.
